(19) United States
(12) Patent Application Publication
(10) Pub. No.: US 2012/0327518 A1
(43) Pub. Date: Dec. 27, 2012

(54) ZOOM LENS AND IMAGING APPARATUS

(75) Inventor: Hiroki Yamano, Tokyo (JP)

(73) Assignee: Sony Corporation, Tokyo (JP)

(21) Appl. No.: 13/478,816

(22) Filed: May 23, 2012

(30) Foreign Application Priority Data
Jun. 23, 2011 (JP) 2011-139710

(51) Int. Cl. G02B 15/14

(52) U.S. Cl. 359/684; 359/687

(57) ABSTRACT

A zoom lens includes, in order from the object side to the image side: a first lens group that has a positive refractive power; a second lens group that has a negative refractive power; a third lens group that has a positive refractive power; and a fourth lens group that has a positive refractive power

### FIELD

The present technology relates to a zoom lens and an imaging apparatus. Specifically, the present technology relates to a technical field of a zoom lens, which has a high zoom ratio and a sufficient speed and is suitable for a digital still camera, a digital video camera, a surveillance camera, or the like capable of achieving an increase in imaging angle of view sufficiently, and an imaging apparatus using the zoom lens.

### BACKGROUND

Recently, as the digital still camera market has increased, users have varied demands for digital still cameras. To say nothing of an increase in image quality, a decrease in size, and a decrease in thickness, demand for an increase in the magnification of the image taking lens and an increase in the angle of view has also increased.

Generally, a positive lead type zoom lens of which a lens group closest to the object side has a positive refractive power is a type of zoom lens used in an imaging apparatus such as a digital camera. The positive lead type zoom lens is advantageous in an increase in a zoom ratio and is advantageous in that the optical system can be designed so as to be fast across an entire zoom range. Hence, for example, the positive lead type zoom lens has been widely used as a type appropriate for a high-power zoom lens in which the zoom ratio is greater than five magnifications.

In particular, as a positive lead type small zoom lens, there is a well-known zoom lens which has a four-group configuration including lens groups having positive, negative, positive, positive refractive powers arranged in order from the object side to the image side (for example, refer to JP-A-2010-204148, JP-A-2010-181543, JP-A-2010-217478, JP-A-2009-294302, and JP-A-2007-10695).

### SUMMARY

However, the zoom lenses described in JP-A-2010-204148 and JP-A-2010-181543 achieve an increase in magnification ratio, but do not achieve a sufficient speed of the F number.

On the other hand, in the zoom lenses described in JP-A-2010-217478 and JP-A-2009-294302, the F number thereof is set to achieve a high speed, but a sufficiently high magnification ratio is not achieved.

Further, generally, the zoom lens having a four-group configuration of positive, negative, positive, and positive groups is a type characterized in that the diameter of the lens of the first lens group closest to the object side tends to increase. Hence, the zoom lenses described in JP-A-2010-204148, JP-A-2010-181543, JP-A-2010-217478, JP-A-2009-294302 do not achieve both an increase in imaging view angle and a decrease in size.

Furthermore, in order to achieve an increase in angle of view and an increase in magnification ratio of the optical system, it is necessary to satisfactorily correct aberrations and reduce an effect on image quality caused by assembly errors at the time of manufacture. Hence, generally a large number of lenses are used, and the entire length of the optical system is increased.

The zoom lens described in JP-A-2007-10695 achieves an increase in angle of view and an increase in magnification ratio. However, in terms of satisfactorily correcting aberrations and reducing an effect on image quality caused by assembly errors at the time of manufacture as described above, it may be inevitable that the number of lenses and the entire length of the optical system are increased. Hence, reduction in size of the zoom lens is not sufficiently achieved.

In particular, in a collapsible zoom lens that houses a lens by collapsing the lens when not using the camera (when not performing photography), it is difficult to decrease a thickness of the collapsible camera by reducing the number of lenses and the thickness thereof. Hence, there is a strong demand for development of a small-sized and lightweight zoom lens capable of achieving an increase in angle of view and an increase in magnification ratio.

Further, in an imaging apparatus, using a solid-state imaging device, it is preferable to use a zoom lens which is approximately telecentric on the image side since it is possible to make the illuminance on the image plane uniform. As the zoom lens, a zoom lens, of which the lens group closest to the image side has a positive refractive power, is appropriate.

Therefore, it is desirable to provide a zoom lens and an imaging apparatus that have a small size, are fast in the entire zoom range, have high optical performance, and sufficiently achieve an increase in imaging view angle.

An embodiment of the present technology is directed to a zoom lens including, in order from the object side to the image side: a first lens group that has a positive refractive power; a second lens group that has a negative refractive power; a third lens group that has a positive refractive power; and a fourth lens group that has a positive refractive power. During zooming from a wide-angle end to a telephoto end, the first lens group moves toward the object side so as to increase a space between the first lens group and the second lens group, and the third lens group moves toward the object side so as to decrease a space between the third lens group and the second lens group. The second lens group is formed of three separate lenses of a first negative lens, a second negative lens, and a positive lens arranged in order from the object side to the image side. An object-side surface of the positive lens is formed as an aspheric surface having a shape of which a curvature is smaller at a position closer to a peripheral portion thereof on an optical axis. An F number thereof at the wide-angle end is less than 3.0, and a zoom ratio thereof is greater than or equal to 7.5. The zoom lens satisfies the following Conditional Expression (1).

1.5<Move3(wt)/fw<3.5 (1)

Here, Move3(wt) is a movement distance of the third lens group during zooming from the wide-angle end to the telephoto end, and fw is a focal length of the whole optical system at the wide-angle end.

Accordingly, in the zoom lens, the second lens group is formed of a small number of lenses, for example, three lenses, and a coma aberration of an angle of view at the periphery from the wide-angle end to the telephoto end and a spherical aberration of an angle of view on the axis at the telephoto end are effectively corrected.

In the zoom lens of the embodiment of the present technology, it is preferable that the zoom lens satisfies the following Conditional Expression (2).

1.5<10×{Move3(wt)/fw}/Zoom<2.8 (2)

Here, Zoom is a zoom ratio of the whole optical system during zooming from the wide-angle end to the telephoto end.

By making the zoom lens satisfy the Conditional Expression (2), the movement distance of the third lens group is optimized for the zoom ratio of the optical system.

In the zoom lens of the embodiment of the present technology, it is preferable that the above-mentioned zoom lens satisfies the following Conditional Expression (3).

1.2<{R23f/(nd23−1)}/|f2|<1.9 (3)

Here, R23f is a paraxial radius of curvature of the object-side surface of the positive lens in the second lens group, nd23 is a refractive index of the positive lens in the second lens group at the d-line, and f2 is a focal length of the second lens group.

By making the zoom lens satisfy the Conditional Expression (3), the positive refractive power of the object-side surface of the positive lens in the second lens group is appropriately set.

In the zoom lens of the embodiment of the present technology, it is preferable that the zoom lens satisfies the following Conditional Expression (4).

vd23<20 (4)

Here, vd23 is an Abbe number of the positive lens in the second lens group at the d-line.

By making the zoom lens satisfy the Conditional Expression (4), reduction in size of the optical system is secured, and then a lateral chromatic aberration on the wide-angle end side and a longitudinal chromatic aberration on the telephoto end side are satisfactorily corrected.

In the zoom lens of the embodiment of the present technology, it is preferable that an aperture stop moves integrally with the third lens group in an optical axis direction, and it is preferable that the zoom lens satisfies the following Conditional Expression (5).

3.5<f12t/f12w<5.5 (5)

Here, f12w is a composite focal length of the first lens group and the second lens group at the wide-angle end, and f12t is a composite focal length of the first lens group and the second lens group at the telephoto end.

By making the zoom lens satisfy the Conditional Expression (5) when the aperture stop moves integrally with the third lens group in the optical axis direction, a favorable power variation effect obtained by the third lens group and a favorable power variation effect obtained by the first and second lens groups are secured.

In the zoom lens of the embodiment of the present technology, it is preferable that the zoom lens satisfies the following Conditional Expression (6).

1.0<|f2|/fw<1.2 (6)

Here, f2 is a focal length of the second lens group.

By making the zoom lens satisfy the Conditional Expression (6), the refractive power of the second lens group is appropriately set.

In the zoom lens of the embodiment of the present technology, it is preferable that the zoom lens satisfies the following Conditional Expression (7).

1.95<f3/fw<2.5 (7)

Here, f3 is a focal length of the third lens group.

By making the zoom lens satisfy the Conditional Expression (7), the refractive power of the third lens group is appropriately set.

In the zoom lens of the embodiment of the present technology, it is preferable that, during focusing from an infinitely distant object to a close-range object, the fourth lens group be brought into focus by moving the lens group in the optical axis direction so as to change a position of an image plane.

By moving the fourth lens group in the optical axis direction so as to change the position of the image plane and bring the fourth lens group into focus during focusing from the infinitely distant object to the close-range object, it is possible to simplify a configuration of the focusing mechanism.

In the zoom lens of the embodiment of the present technology, it is preferable that the fourth lens group is formed of only one positive lens, and it is preferable that the zoom lens satisfies the following Conditional Expression (8).

vd4>80 (8)

Here, vd4 is an Abbe number of the positive lens of the fourth lens group at the d-line.

By making the zoom lens satisfy the Conditional Expression (8), occurrence of a chromatic aberration caused by focusing on the telephoto-end side is reduced.

In the zoom lens of the embodiment of the present technology, it is preferable that the fourth lens group be formed of only a cemented lens which is formed by cementing two lenses of a positive lens and a negative lens arranged in order from the object side to the image side.

By adopting the configuration in which the fourth lens group is formed of only the cemented lens which is formed by cementing the two lenses of the positive lens and the negative lens arranged in order from the object side to the image side, it is possible to simplify a configuration of the focusing mechanism.

Another embodiment of the present technology is directed to an imaging apparatus including: a zoom lens; and an imaging device that converts an optical image, which is formed by the zoom lens, into an electrical signal. The zoom lens includes, in order from the object side to the image side, a first lens group that has a positive refractive power, a second lens group that has a negative refractive power, a third lens group that has a positive refractive power, and a fourth lens group that has a positive refractive power. During zooming from a wide-angle end to a telephoto end, the first lens group moves toward the object side so as to increase a space between the first lens group and the second lens group, and the third lens group moves toward the object side so as to decrease a space between the third lens group and the second lens group. The second lens group is formed of three separate lenses of a first negative lens, a second negative lens, and a positive lens arranged in order from the object side to the image side. An object-side surface of the positive lens is formed as an aspheric surface having a shape of which a curvature is smaller at a position closer to a peripheral portion thereof on an optical axis. An F number thereof at the wide-angle end is less than 3.0, and a zoom ratio thereof is greater than or equal to 7.5. The zoom lens satisfies the Conditional Expression (1).

Accordingly, in the zoom lens in the imaging apparatus, the second lens group is formed of a small number of lenses, for example, three lenses, and a coma aberration of an angle of view at the periphery from the wide-angle end to the telephoto end and a spherical aberration of an angle of view on the axis at the telephoto end are effectively corrected.

The zoom lens and the imaging apparatus according to the embodiments of the present technology have a small size, are fast in the entire zoom range, have high optical performance, and sufficiently achieve an increase in imaging view angle.

### BRIEF DESCRIPTION OF THE DRAWINGS

FIG. 1 is a conceptual diagram illustrating an object-side surface of a positive lens in a second lens group in a preferred embodiment for embodying an imaging apparatus and a zoom lens according to the present technology, similar to FIGS. 2 to 27;

FIG. 2 is a conceptual diagram illustrating object-side surfaces of positive lenses in second lens groups of zoom lenses according to respective embodiments;

FIG. 3 is a diagram illustrating a lens configuration of a zoom lens according to a first embodiment;

FIG. 4 is a diagram illustrating aberrations of a numerical example in which specific numerical values are applied to the first embodiment, similar to FIG. 5, where the aberrations include spherical aberration, astigmatism, and distortion in the wide-angle end state;

FIG. 5 is a diagram illustrating spherical aberration, astigmatism and distortion in the telephoto end state;

FIG. 6 is a diagram illustrating a lens configuration of a zoom lens according to a second embodiment;

FIG. 7 is a diagram illustrating aberrations of a numerical example in which specific numerical values are applied to the second embodiment, similar to FIG. 8, where the aberrations include spherical aberration, astigmatism, and distortion in the wide-angle end state;

FIG. 8 is a diagram illustrating spherical aberration, astigmatism and distortion in the telephoto end state;

FIG. 9 is a diagram illustrating a lens configuration of a zoom lens according to a third embodiment;

FIG. 10 is a diagram illustrating aberrations of a numerical example in which specific numerical values are applied to the third embodiment, similar to FIG. 11, where the aberrations include spherical aberration, astigmatism, and distortion in the wide-angle end state;

FIG. 11 is a diagram illustrating spherical aberration, astigmatism and distortion in the telephoto end state;

FIG. 12 is a diagram illustrating a lens configuration of a zoom lens according to a fourth embodiment;

FIG. 13 is a diagram illustrating aberrations of a numerical example in which specific numerical values are applied to the fourth embodiment, similar to FIG. 14, where the aberrations include spherical aberration, astigmatism, and distortion in the wide-angle end state;

FIG. 14 is a diagram illustrating spherical aberration, astigmatism and distortion in the telephoto end state;

FIG. 15 is a diagram illustrating a lens configuration of a zoom lens according to a fifth embodiment;

FIG. 16 is a diagram illustrating aberrations of a numerical example in which specific numerical values are applied to the fifth embodiment, similar to FIG. 17, where the aberrations include spherical aberration, astigmatism, and distortion in the wide-angle end state;

FIG. 17 is a diagram illustrating spherical aberration, astigmatism and distortion in the telephoto end state;

FIG. 18 is a diagram illustrating a lens configuration of a zoom lens according to a sixth embodiment;

FIG. 19 is a diagram illustrating aberrations of a numerical example in which specific numerical values are applied to the sixth embodiment, similar to FIG. 20, where the aberrations include spherical aberration, astigmatism, and distortion in the wide-angle end state;

FIG. 20 is a diagram illustrating spherical aberration, astigmatism and distortion in the telephoto end state;

FIG. 21 is a diagram illustrating a lens configuration of a zoom lens according to a seventh embodiment;

FIG. 22 is a diagram illustrating aberrations of a numerical example in which specific numerical values are applied to the seventh embodiment, similar to FIG. 23, where the aberrations include spherical aberration, astigmatism, and distortion in the wide-angle end state;

FIG. 23 is a diagram illustrating spherical aberration, astigmatism and distortion in the telephoto end state;

FIG. 24 is a diagram illustrating a lens configuration of a zoom lens according to an eighth embodiment;

FIG. 25 is a diagram illustrating aberrations of a numerical example in which specific numerical values are applied to the eighth embodiment, similar to FIG. 26, where the aberrations include spherical aberration, astigmatism, and distortion in the wide-angle end state;

FIG. 26 is a diagram illustrating spherical aberration, astigmatism and distortion in the telephoto end state; and

FIG. 27 is a block diagram illustrating an example of an imaging apparatus.

### DETAILED DESCRIPTION

Hereinafter, preferred embodiments for embodying a zoom lens and an imaging apparatus according to the present technology will be described.

### [Configuration of Zoom Lens]

The zoom lens according to the present technology includes, in order from the object side to the image side: a first lens group that has a positive refractive power; a second lens group that has a negative refractive power; a third lens group that has a positive refractive power; and a fourth lens group that has a positive refractive power.

Further, in the zoom lens according to the present technology, during zooming from the wide-angle end to the telephoto end, the first lens group moves toward the object side so as to increase a space between the first lens group and the second lens group, and the third lens group moves toward the object side so as to decrease a space between the third lens group and the second lens group.

By making the zoom lens have the above-mentioned configuration, it is possible to maximize a power variation effect of the third lens group and the second lens group highly contributing to a power variation effect of the optical system during zooming, and it is possible to reduce the size of the whole optical system by reducing the entire length thereof. Accordingly, even in a case of a high-power zoom lens of which the zoom ratio is greater than 7.5 magnifications, it is possible to sufficiently reduce the size thereof.

Further, as a most preferable example, in particular, it is preferable to increase a magnification ratio to be greater than 8.5 magnifications. In the zoom lens according to the present technology, it is possible to cope with such a high-level demand of the market.

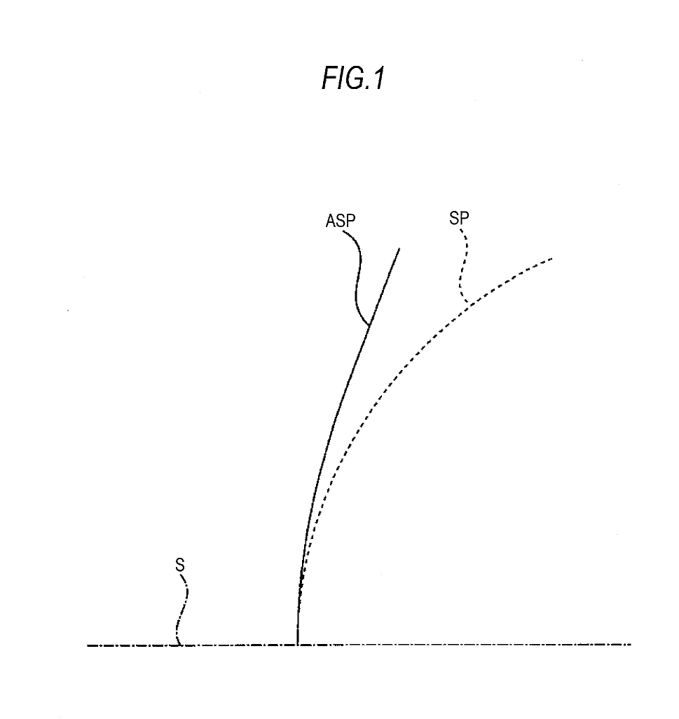

In the zoom lens according to the present technology, the second lens group is formed of three separate lenses of a first negative lens, a second negative lens, and a positive lens arranged in order from the object side to the image side. In addition, the object-side surface of the positive lens is formed as an aspheric surface having a shape of which the curvature becomes gradually smaller at a position closer to a peripheral portion thereof on the optical axis (refer to FIG. 1).

FIG. 1 conceptually shows the object-side surface of the positive lens in the second lens group, where SP represents a paraxial radius of curvature, and ASP represents an aspheric surface. Regarding the aspheric surface ASP, as the distance from the optical axis S toward the peripheral portion thereof decreases, the distance between the aspheric surface ASP and the paraxial radius of curvature SP in the optical axis direction is increased, and the curvature thereof is set to gradually decrease.

In the zoom lens according to the present technology, the second lens group is formed of three separate lenses of the first negative lens, the second negative lens, and the positive lens arranged in order from the object side to the image side. In addition, the object-side surface of the positive lens is formed as an aspheric surface having a shape of which the curvature becomes gradually smaller at a position closer to the peripheral portion thereof on the optical axis.

By making the second lens group have the above-mentioned configuration, even when the second lens group is formed of a small number of lenses for example three lenses, it is possible to effectively correct a coma aberration of an angle of view at the periphery from the wide-angle end to the telephoto end and a spherical aberration of an angle of view on the axis at the telephoto end. Hence, it is possible to improve image quality.

Furthermore, the aspheric surface shape is particularly advantageous in the following cases: a case of designing a zoom lens of which the F number at the wide-angle end is less than or equal to 3.5 and the F number at the telephoto end is less than or equal to 6.0 and which is sufficiently fast at the time of normal photography; and a case of designing a high zoom lens of which the F number at the wide-angle end is less than 3.0 and the F number at the telephoto end is less than 5.0 and which is particularly fast and has a high aperture (refer to Examples 1 to 8 to be described later).

In the zoom lens according to the present technology, the F number thereof at the wide-angle end is less than 3.0, and the zoom ratio thereof is greater than or equal to 7.5.

Further, the zoom lens according to the present technology satisfies the following Conditional Expression (1)

1.5<Move3(wt)/fw<3.5 (1)

Here, Move3(wt) is a movement distance of the third lens group during zooming from the wide-angle end to the telephoto end, and fw is a focal length of the whole optical system at the wide-angle end.

The Conditional Expression (1) defines the movement distance of the third lens group during zooming from the wide-angle end to the telephoto end.

If the resulting value of the Conditional Expression (1) is excessively larger than the upper limit thereof, the power variation effect caused by the third lens group is too large. Hence, the power variation effect caused by the first lens group and the second lens group decreases relatively. As a result, the magnification ratio of the entrance pupil diameter becomes insufficient. Thus, it is difficult to set the F number at the telephoto end so as to achieve a sufficiently high speed.

In contrast, if the resulting value of the Conditional Expression (1) becomes excessively smaller than the lower limit thereof, the power variation effect caused by the third lens group that contributes most to the power variation becomes insufficient. Hence, it is difficult to sufficiently increase the magnification ratio.

Accordingly, by making the zoom lens satisfy the Conditional Expression (1), a favorable power variation effect caused by the first lens group and the second lens group is secured, and thus the F number at the telephoto end can be set to achieve a sufficiently high speed, and a favorable power variation effect caused by the third lens group is secured, and thus it is possible to sufficiently increase the magnification ratio.

In one embodiment of the present technology, it is preferable that the zoom lens satisfies the following Conditional Expression (2).

1.5<10×{Move3(wt)/fw}/Zoom<2.8, (2)

Here, Zoom is a zoom ratio of the whole optical system during zooming from the wide-angle end to the telephoto end.

The Conditional Expression (2) defines a proportion of the zoom ratio to the movement distance of the third lens group during zooming from the wide-angle end to the telephoto end.

By making the zoom lens satisfy the Conditional Expression (2), it is possible to most appropriately set the movement distance of the third lens group described in the Conditional Expression (1) at the zoom ratio of the optical system.

In one embodiment of the present technology, it is more preferable that the zoom lens according to the present technology satisfies the following Conditional Expression (2)′.

1.8<10×{Move3(wt)/fw}/Zoom<2.7 (2)′

By making the zoom lens satisfy the Conditional Expression (2)′, it is possible to most appropriately set the movement distance of the third lens group at the zoom ratio of the optical system.

In one embodiment of the present technology, it is preferable that the zoom lens according to the present technology satisfies the following Conditional Expression (3).

1.2<{R23f/(nd23−1)}/|f2|<1.9 (3)

Here, R23f is a paraxial radius of curvature of the object-side surface of the positive lens in the second lens group, nd23 is a refractive index of the positive lens in the second lens group at the d-line, and f2 is a focal length of the second lens group.

The Conditional Expression (3) defines the refractive power of the object-side surface of the positive lens in the second lens group.

If the resulting value of the Conditional Expression (3) becomes excessively smaller than the lower limit thereof, the positive refractive power of the object-side surface of the positive lens in the second lens group becomes too strong. In particular, it is difficult to correct a coma aberration at the wide-angle end and the telephoto end and a spherical aberration at the telephoto end. In addition, since sensitivity in eccentricity of the positive lens is excessively high, difficulty in the finishing of manufacture is excessively high.

In contrast, if the resulting value of the Conditional Expression (3) becomes excessively larger than the upper limit, the positive refractive power of the object-side surface of the positive lens becomes too weak. Hence, it is difficult to make the image-side principal point of the second lens group sufficiently close to the object side. Accordingly, it is difficult to make the position of the entrance pupil at the wide-angle end sufficiently close to the object side. As a result, the lens diameter, in particular, the sizes of the first lens group and the second lens group in the diameter direction increase.

Accordingly, by making the zoom lens satisfy the Conditional Expression (3), the positive refractive power of the object-side surface of the positive lens in the second lens group is appropriately set. Thus, it is possible to satisfactorily correct aberrations and reduce difficulty in manufacture, and it is possible to reduce the lens diameter, in particular, the sizes of the first lens group and the second lens group in the diameter direction.

In one embodiment of the present technology, it is more preferable that the zoom lens according to of the present technology satisfies the following Conditional Expression (3)′.

1.42<{R23f/(nd23−1)}/|f2|<1.8 (3)′

By making the zoom lens satisfy the Conditional Expression (3)′, it is possible to further appropriately set the positive refractive power of the object-side surface of the positive lens in the second lens group.

In one embodiment of the present technology, it is preferable that the zoom lens according to the present technology satisfies the following Conditional Expression (4).

vd23<20 (4)

Here, vd23 is an Abbe number of the positive lens in the second lens group at the d-line.

The Conditional Expression (4) defines the Abbe number of the positive lens in the second lens group at the d-line.

If the resulting value of the Conditional Expression (4) becomes excessively larger than the range thereof, it is difficult to appropriately correct a longitudinal chromatic aberration on the telephoto end side and a lateral chromatic aberration on the wide-angle end side occurring in the second lens group. Thus, it may be inevitable that image quality deteriorates, or the size of the optical system is increased in order to secure high image quality.

Accordingly, by making the zoom lens satisfy the Conditional Expression (4), reduction in size of the optical system is secured, and then a lateral chromatic aberration on the wide-angle end side and a longitudinal chromatic aberration on the telephoto end side are satisfactorily corrected. As a result, it is possible to improve image quality.

In one embodiment of the zoom lens according to the present technology, it is preferable that the aperture stop moves integrally with the third lens group in the optical axis direction, and it is preferable that the zoom lens satisfies the following Conditional Expression (5).

3.5<f12t/f12w<5.5 (5)

Here, f12w is a composite focal length of the first lens group and the second lens group at the wide-angle end, and f12t is a composite focal length of the first lens group and the second lens group at the telephoto end.

The Conditional Expression (5) defines a proportion of the composite focal lengths of the first lens group and the second lens group during zooming from the wide-angle end to the telephoto end.

If the resulting value of the Conditional Expression (5) becomes excessively larger than the upper limit, the power variation effect caused by the first lens group and the second lens group becomes too great. Hence, the power variation effect caused by the third lens group relatively that contributes most to the power variation becomes insufficient. Hence, it is difficult to sufficiently increase the magnification ratio.

In contrast, if the resulting value of the Conditional Expression (5) becomes excessively smaller than the lower limit, the power variation effect caused by the first lens group and the second lens group becomes lower. As a result, the magnification ratio of the entrance pupil diameter becomes insufficient. Thus, it is difficult to set the F number at the telephoto end so as to achieve a sufficiently high speed.

Accordingly, by making the zoom lens satisfy the Conditional Expression (5), a favorable power variation effect caused by the third lens group is secured, and a favorable power variation effect caused by the first lens group and the second lens group is secured. Thus, the F number at the telephoto end can be set to achieve a sufficiently high speed.

In one embodiment of the present technology, it is preferable that the zoom lens according to the present technology satisfies the following Conditional Expression (6).

1.0<|f2|/fw<1.2 (6)

Here, f2 is a focal length of the second lens group.

The Conditional Expression (6) defines the focal length of the second lens group.

If the resulting value of the Conditional Expression (6) becomes excessively larger than the upper limit, the refractive power of the second lens group becomes too weak. Hence, the size of the optical system is increased.

In contrast, if the resulting value of the Conditional Expression (6) becomes excessively smaller than the lower limit, the refractive power of the second lens group becomes too strong. Hence, it is difficult to correct aberrations, and thus image quality deteriorates.

Accordingly, by making the zoom lens satisfy the Conditional Expression (6), the refractive power of the second lens group is appropriately set. Thus, it is possible to improve image quality by reducing the size of the optical system and satisfactorily correcting aberrations.

In one embodiment of the present technology, it is possible that the zoom lens according to the present technology satisfies the following Conditional Expression (7).

1.95<f3/fw<2.5 (7)

Here, f3 is a focal length of the third lens group.

The Conditional Expression (7) defines the focal length of the third lens group.

If the resulting value of the Conditional Expression (7) becomes excessively larger than the upper limit, the refractive power of the third lens group becomes too weak. Hence, the size of the optical system is increased.

In contrast, if the resulting value of the Conditional Expression (7) becomes excessively smaller than the lower limit, the refractive power of the third lens group becomes too strong. Hence, it is difficult to correct aberrations, and thus image quality deteriorates.

Accordingly, by making the zoom lens satisfy the Conditional Expression (7), the refractive power of the third lens group is appropriately set, and thus it is possible to improve image quality by reducing the size of the optical system and satisfactorily correcting aberrations.

In one embodiment of the zoom lens according to the present technology, it is preferable that, during focusing from an infinitely distant object to a close-range object, the fourth lens group is brought into focus by moving the lens group in the optical axis direction so as to change a position of the image plane.

In the zoom lens, during focusing, by moving the fourth lens group and changing the position of the image plane so as to bring the lens group into focus, as compared with the case of performing the focusing by the first and second lens groups of which the outer diameters and the weights tend to relatively increase, it is possible to simplify design of the configuration of the focusing mechanism. Accordingly, not only it becomes easy to reduce the size of the lens barrel, but also it is possible to reduce the load, which is caused by the weight, to an actuator used to move the lens groups in the optical axis direction.

In one embodiment of the zoom lens according to the present technology, it is preferable that the fourth lens group is formed of only one positive lens, and it is preferable that the zoom lens satisfies the following Conditional Expression (8).

vd4>80 (8)

Here, vd4 is an Abbe number of the positive lens of the fourth lens group at the d-line.

By adopting the configuration in which the fourth lens group is formed of only one positive lens, it is possible to simplify the configuration of the fourth lens group, and it is possible to maximize the advantage in design of the above-mentioned focusing mechanism.

The Conditional Expression (8) defines the Abbe number of the positive lens of the fourth lens group at the d-line.

If the resulting value of the Conditional Expression (8) becomes excessively smaller than the range thereof, it is difficult to correct a chromatic aberration occurring in the fourth lens group. Hence, image quality deteriorates.

Accordingly, by making the zoom lens satisfy the Conditional Expression (8), in particular, it is possible to reduce occurrence of the chromatic aberration caused by the focusing on the telephoto end side. Hence, it is possible to achieve high image quality at a subject distance ranging from an infinite distance to a close distance. In particular, in the zoom lens of which the F number is set to achieve a quite high speed in the entire zoom range according to the present technology, it tends to be difficult to correct a coma aberration caused by the focusing. Hence, it is remarkably advantageous to adopt the above-mentioned configuration of the fourth lens group.

In one embodiment of the zoom lens according to the present technology, it is preferable that the fourth lens group be formed of only a cemented lens which is formed by cementing two lenses of a positive lens and a negative lens arranged in order from the object side to the image side.

In the zoom lens, by adopting the configuration in which the fourth lens group is formed of only the cemented lens which is formed by cementing the two lenses of the positive lens and the negative lens, it is possible to secure an advantage in design of the focusing mechanism or an advantage in image quality resulting from the focusing.

### [Numerical Examples of Zoom Lens]

Hereinafter, numerical examples will be described with reference to the accompanying drawings and tables, in which specific numerical values are applied to the zoom lens according to the embodiment of the present technology.

Note that, in the accompanying drawings and tables, the reference signs and the like are defined as follows.

“Si” represents an i-th surface counted from the object side to the image side, “Ri” represents a paraxial radius of curvature of the i-th surface, “Di” represents an on-axis surface space between the i-th surface and an (i+1)th surface (the thickness or the air gap at the center of the lens), “ni” represents a refractive index of a lens or the like including the i-th surface at the d-line (λ=587.6 nm), and “vi” represents an Abbe number of the lens or the like including the i-th surface at the d-line.

Regarding “Si”, “ASP” indicates that the corresponding surface is aspheric, “STO” indicates that the corresponding surface is an aperture stop, “IMG” indicates that the corresponding surface is an image plane. In addition, regarding “Ri”, “INFINITY” indicates that the corresponding surface is planar.

“κ” represents a conic constant, and “A”, “B”, “C”, and “D” respectively represent 4th-order, 6th-order, 8th-order, and 10th-order aspheric surface coefficients.

“f” represents a focal length, “Fno” represents an F number, and “ω” represents a half angle of view.

In addition, in the respective tables showing the aspheric surface coefficients to be described below, the reference sign “E-n” represents an exponential expression having a base of 10, that is, “10⁻ⁿ”. For example, “0.12345E-05” represents “0.12345×10⁻⁵”.

Some zoom lenses used in the embodiments are configured so that the lens surface is formed to be aspheric. Here, it is assumed that “x” is the distance (the sag amount) from the vertex of the lens surface in the direction of the optical axis, “y” is the height (the image height) in the direction perpendicular to the direction of the optical axis, “c” is the paraxial radius of curvature (the inverse of the radius of curvature) at the vertex of the lens, “κ” is the conic constant, and “A”, “B”, “C”, and “D” are respectively the 4th-order, 6th-order, 8th-order, and 10th-order aspheric surface coefficients, the aspheric surface shape is defined as the following Numerical Expression 1.

$$x = \frac{{cy}^{2}}{1 + {\{ 1 - ( 1 + κ ) {c}^{2} {y}^{2} \}}^{1 / 2}} + {Ay}^{4} + {By}^{6} + … \qquad Numerical Expression 1$$

Each of zoom lenses 1 to 8 according to the respective embodiments includes, in order from the object side to the image side: a first lens group GR1 with a positive refractive power; a second lens group GR2 with a negative refractive power; a third lens group GR3 with a positive refractive power; and a fourth lens group GR4 with a positive refractive power.

Further, in each of the zoom lenses 1 to 8 according to the respective embodiments, during zooming from the wide-angle end to the telephoto end, the first lens group GR1 moves toward the object side so as to increase a space between the first lens group GR1 and the second lens group GR2, and the third lens group GR3 moves toward the object side so as to decrease a space between the third lens group GR3 and the second lens group GR2.

Furthermore, in each of the zoom lenses 1 to 8 according to the respective embodiments, the second lens group GR2 has a single positive lens, and the object-side surface of the positive lens is formed as an aspheric surface having a shape of which the curvature becomes gradually smaller at a position closer to the peripheral portion thereof on the optical axis.

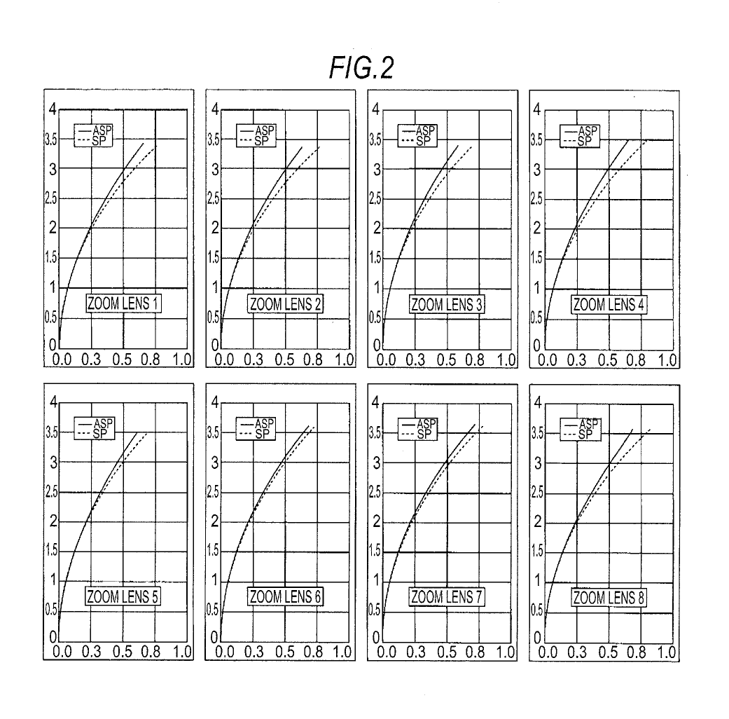

FIG. 2 conceptually shows the object-side surface of the positive lens in the second lens group. Here, the horizontal axis indicates a distance (mm) in the optical axis direction, and the vertical axis indicates a distance (unit mm) from the optical axis. SP (dashed line) indicates the paraxial radius of curvature, and ASP (solid line) indicates the aspheric surface. Regarding the aspheric surface ASP, as the distance from the optical axis toward the peripheral portion thereof decreases, the distance between the aspheric surface ASP and the paraxial radius of curvature SP in the optical axis direction is increased, and the curvature thereof is set to gradually decrease.

### First Embodiment

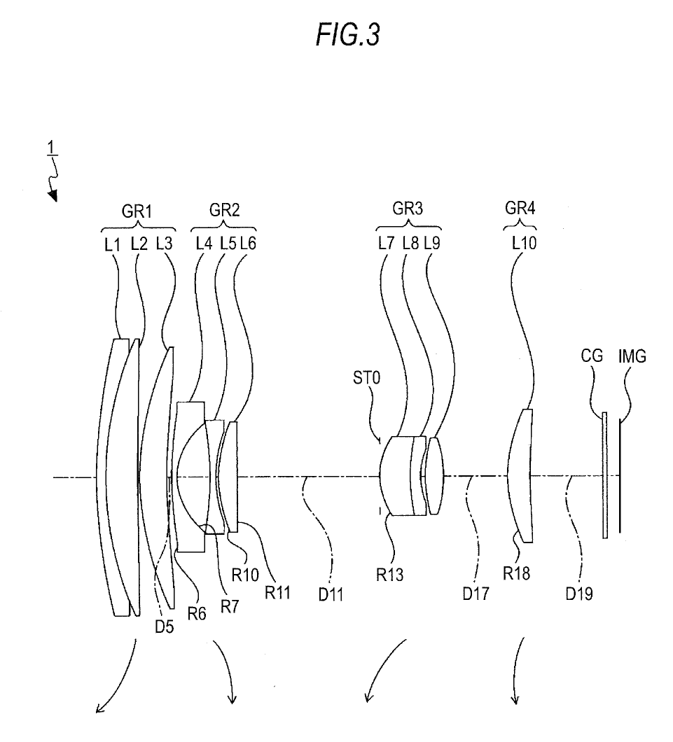

FIG. 3 shows a lens configuration of the zoom lens 1 according to the first embodiment of the present technology.

The zoom lens 1 includes, in order from the object side to the image side: a first lens group GR1 with a positive refractive power; a second lens group GR2 with a negative refractive power; a third lens group GR3 with a positive refractive power; and a fourth lens group GR4 with a positive refractive power.

The zoom lens 1 has a zoom ratio of 10.78 magnifications.

The first lens group GR1 includes, in order from the object side to the image side: a cemented lens that is formed by cementing a negative lens L1, which is convex toward the object side and has a meniscus shape, and a positive lens L2 which is convex toward the object side and has a meniscus shape; and a positive lens L3 which is convex toward the object side and has a meniscus shape.

The second lens group GR2 includes, in order from the object side to the image side: a first negative lens L4 that is convex toward the object side; a second negative lens L5 that has a biconcave shape; and a positive lens L6 that is convex toward the object side and has a meniscus shape.

The third lens group GR3 includes, in order from the object side to the image side: a cemented lens that is formed by cementing a positive lens L7, which is convex toward the object side and has a meniscus shape, and a negative lens L8 which is convex toward the object side; and a positive lens L9 that has a biconvex shape.

The fourth lens group GR4 includes a positive lens L10 that is convex toward the object side and has a meniscus shape.

A cover glass CG is disposed between the fourth lens group GR4 and an image plane IMG.

An aperture stop STO is disposed near the object side of the third lens group GR3 between the second lens group GR2 and the third lens group GR3, and is shifted integrally with the third lens group GR3 in the optical axis direction.

Table 1 shows the lens data of Numerical Example 1 of the zoom lens 1, to which specific numerical values are applied, according to the first embodiment.

TABLE 1

| Si | Ri | Di | ni | νi |
|---|---|---|---|---|
| 1 | 38.931 | 0.700 | 1.92286 | 20.880 |
| 2 | 24.694 | 2.319 | 1.59282 | 68.624 |
| 3 | 307.961 | 0.150 | | |
| 4 | 21.627 | 2.009 | 1.72916 | 54.674 |
| 5 | 65.674 | (D5) | | |
| 6(ASP) | 186.547 | 0.400 | 1.80139 | 45.450 |
| 7(ASP) | 5.402 | 2.502 | | |
| 8 | −21.500 | 0.450 | 1.80420 | 46.503 |
| 9 | 9.637 | 0.200 | | |
| 10(ASP) | 8.000 | 1.290 | 2.00170 | 19.324 |
| 11(ASP) | 25.608 | (D11) | | |
| 12(STO) | INFINITY | 0.000 | | |
| 13(ASP) | 4.724 | 2.250 | 1.68893 | 31.161 |
| 14 | 12.655 | 0.750 | 1.94595 | 17.980 |
| 15 | 4.886 | 0.355 | | |
| 16 | 10.394 | 1.320 | 1.61800 | 63.390 |
| 17 | −10.394 | (D17) | | |
| 18(ASP) | 10.719 | 1.600 | 1.49710 | 81.560 |
| 19 | 50.000 | (D19) | | |
| 20 | INFINITY | 0.300 | 1.51680 | 64.200 |
| 21 | INFINITY | 1.000 | | |
| 22(IMG) | INFINITY | | | |

In the zoom lens 1, both surfaces (sixth surface and seventh surface) of the first negative lens L4 of the second lens group GR2, both surfaces (tenth surface and eleventh surface) of the positive lens L6 of the second lens group GR2, the object side surface (thirteenth surface) of the positive lens L7 of the third lens group GR3, and the object side surface (eighteenth surface) of the positive lens L10 of the fourth lens group GR4 are formed as aspheric surfaces. Table 2 shows, together with the conic constant κ, the 4th-order, 6th-order, 8th-order, and 10th-order aspheric surface coefficients A, B, C, and D of the aspheric surfaces in Numerical Example 1.

TABLE 2

| Si | κ | A | B | C | D |
|---|---|---|---|---|---|
| 6 | −6.77554E+00 | 2.27088E−03 | −1.23885E−04 | 2.74355E−06 | −2.44033E−08 |
| 7 | 0.00000E+00 | 2.27171E−03 | 1.89868E−05 | 3.25971E−06 | −4.67720E−07 |
| 10 | 2.03508E+00 | −2.02242E−03 | 1.24485E−04 | −8.09854E−06 | 0.00000E+00 |
| 11 | 0.00000E+00 | −1.29065E−03 | 1.04114E−04 | −6.95652E−06 | 1.16616E−07 |
| 13 | 0.00000E+00 | −7.93622E−04 | −5.01239E−06 | −1.30555E−06 | 0.00000E+00 |
| 18 | 0.00000E+00 | −7.14427E−05 | 2.36706E−06 | −1.83600E−08 | −7.77964E−10 |

In the zoom lens 1, during the power variation between the wide-angle end state and the telephoto end state, changes occur in an on-axis surface space D5 between the first lens group GR1 and the second lens group GR2, an on-axis surface space D11 between the second lens group GR2 and the aperture stop S, an on-axis surface space D17 between the third lens group GR3 and the fourth lens group GR4, and an on-axis surface space D19 between the fourth lens group GR4 and the cover glass CG. Table 3 shows, together with the focal length f, the F number Fno, and the half angle of view ω, variable spaces of respective on-axis surface spaces at the wide-angle end state, the middle focal length state, and the telephoto end state in Numerical Example 1.

TABLE 3

| | Wide-Angle | Middle Focal | Telephoto |
|---|---|---|---|
| | End | Length | End |
| f | 4.80 | 15.68 | 51.78 |
| Fno | 2.88 | 3.85 | 4.60 |
| ω | 40.63 | 13.87 | 4.21 |
| D5 | 0.350 | 10.037 | 18.992 |
| D11 | 10.550 | 3.528 | 0.400 |
| D17 | 4.830 | 6.995 | 16.301 |
| D19 | 5.384 | 9.736 | 4.713 |

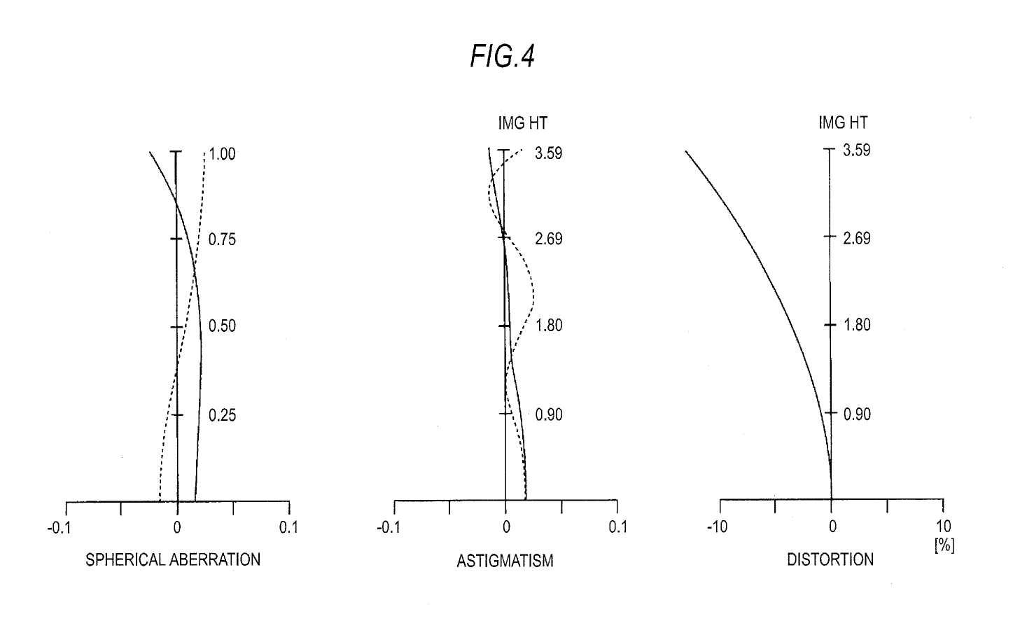

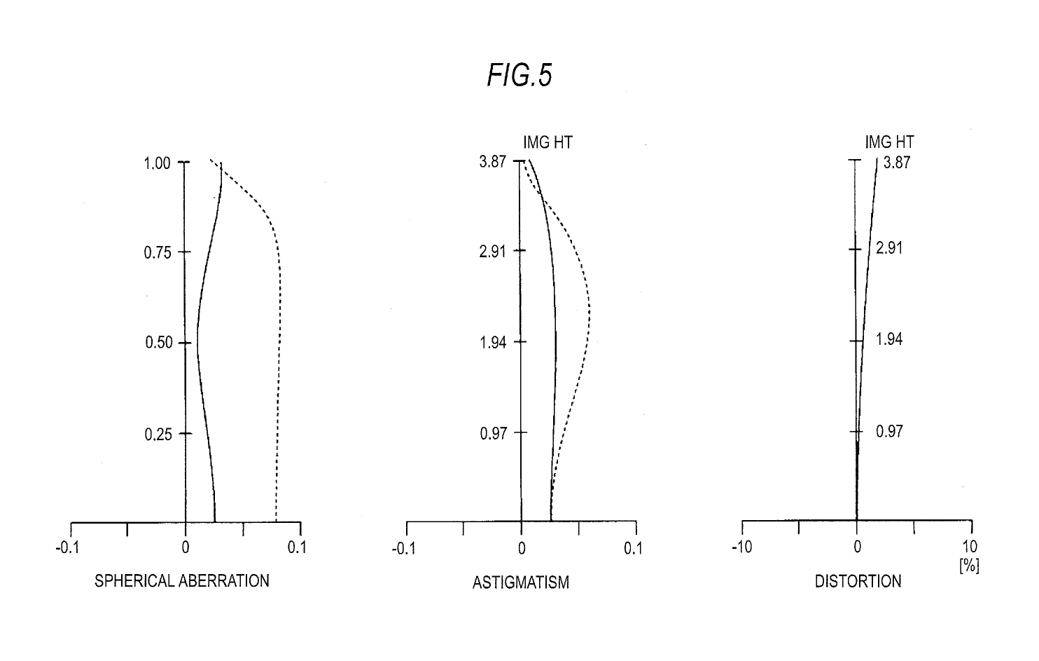

FIGS. 4 and 5 show diagrams of various aberrations in a state where the focus is at infinity in Numerical Example 1, where FIG. 4 shows a diagram of various aberrations at the wide-angle end state and FIG. 5 shows a diagram of various aberrations at the telephoto end state.

In each spherical aberration diagram of FIGS. 4 and 5, the solid line indicates the d-line (the wavelength of 587.6 nm), and the dashed line indicates the g-line (the wavelength of 435.8 nm). In each astigmatism diagram, the solid line indicates a value on the sagittal image plane, and the dashed line indicates a value on the meridional image plane.

As can be clearly seen from the aberration diagrams, in Numerical Example 1, it is possible to obtain excellent imaging performance by satisfactorily correcting various aberrations.

### Second Embodiment

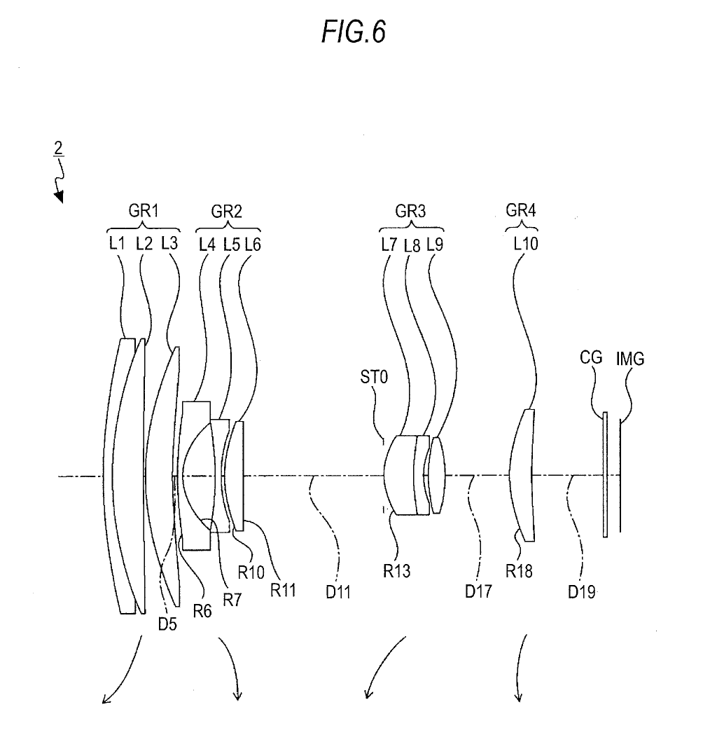

FIG. 6 shows a lens configuration of the zoom lens 2 according to the second embodiment of the present technology.

The zoom lens 2 includes, in order from the object side to the image side: a first lens group GR1 with a positive refractive power; a second lens group GR2 with a negative refractive power; a third lens group GR3 with a positive refractive power; and a fourth lens group GR4 with a positive refractive power.

The zoom lens 2 has a zoom ratio of 10.76 magnifications.

The first lens group GR1 includes, in order from the object side to the image side: a cemented lens that is formed by cementing a negative lens L1, which is convex toward the object side and has a meniscus shape, and a positive lens L2 which is convex toward the object side and has a meniscus shape; and a positive lens L3 which is convex toward the object side and has a meniscus shape.

The second lens group GR2 includes, in order from the object side to the image side: a first negative lens L4 that is convex toward the object side; a second negative lens L5 that has a biconcave shape; and a positive lens L6 that is convex toward the object side and has a meniscus shape.

The third lens group GR3 includes, in order from the object side to the image side: a cemented lens that is formed by cementing a positive lens L7, which is convex toward the object side and has a meniscus shape, and a negative lens L8 which is convex toward the object side; and a positive lens L9 that has a biconvex shape.

The fourth lens group GR4 includes a positive lens L10 that is convex toward the object side and has a meniscus shape.

A cover glass CG is disposed between the fourth lens group GR4 and an image plane IMG.

An aperture stop STO is disposed near the object side of the third lens group GR3 between the second lens group GR2 and the third lens group GR3, and is shifted integrally with the third lens group GR3 in the optical axis direction.

Table 4 shows the lens data of Numerical Example 2 of the zoom lens 2, to which specific numerical values are applied, according to the second embodiment.

TABLE 4

| Si | Ri | Di | ni | νi |
|---|---|---|---|---|
| 1 | 42.750 | 0.700 | 1.92286 | 20.880 |
| 2 | 26.121 | 2.268 | 1.59282 | 68.624 |
| 3 | 499.927 | 0.150 | | |
| 4 | 21.631 | 2.025 | 1.72916 | 54.674 |
| 5 | 67.685 | (D5) | | |
| 6(ASP) | 795.746 | 0.400 | 1.80139 | 45.450 |
| 7(ASP) | 5.720 | 2.461 | | |
| 8 | −21.750 | 0.450 | 1.80420 | 46.503 |
| 9 | 10.250 | 0.200 | | |
| 10(ASP) | 7.800 | 1.252 | 1.94595 | 17.980 |
| 11(ASP) | 22.185 | (D11) | | |
| 12(STO) | INFINITY | 0.000 | | |
| 13(ASP) | 4.672 | 2.150 | 1.68893 | 31.161 |
| 14 | 12.596 | 0.800 | 1.94595 | 17.980 |
| 15 | 4.850 | 0.340 | | |
| 16 | 10.316 | 1.230 | 1.61800 | 63.390 |
| 17 | −10.316 | (D17) | | |
| 18(ASP) | 10.717 | 1.575 | 1.49710 | 81.560 |
| 19 | 50.000 | (D19) | | |
| 20 | INFINITY | 0.300 | 1.51680 | 64.200 |
| 21 | INFINITY | 1.000 | | |
| 22(IMG) | INFINITY | | | |

In the zoom lens 2, both surfaces (sixth surface and seventh surface) of the first negative lens L4 of the second lens group GR2, both surfaces (tenth surface and eleventh surface) of the positive lens L6 of the second lens group GR2, the object side surface (thirteenth surface) of the positive lens L7 of the third lens group GR3, and the object side surface (eighteenth surface) of the positive lens L10 of the fourth lens group GR4 are formed as aspheric surfaces. Table 5 shows, together with the conic constant κ, the 4th-order, 6th-order, 8th-order, and 10th-order aspheric surface coefficients A, B, C, and D of the aspheric surfaces in Numerical Example 2.

TABLE 5

| Si | κ | A | B | C | D |
|---|---|---|---|---|---|
| 6 | 1.34053E+01 | 2.22759E−03 | −1.11778E−04 | 2.25695E−06 | −1.80150E−08 |
| 7 | 0.00000E+00 | 2.19428E−03 | 1.92410E−05 | 4.09356E−06 | −4.54139E−07 |
| 10 | 1.71866E+00 | −2.18187E−03 | 1.30981E−04 | −8.25137E−06 | 0.00000E+00 |
| 11 | 0.00000E+00 | −1.38097E−03 | 1.01622E−04 | −6.74912E−06 | 9.86458E−08 |
| 13 | 0.00000E+00 | −8.07334E−04 | −8.36065E−06 | −1.33902E−06 | 0.00000E+00 |
| 18 | 0.00000E+00 | −7.95246E−05 | 3.26402E−06 | −5.67677E−08 | −1.94570E−10 |

In the zoom lens 2, during the power variation between the wide-angle end state and the telephoto end state, changes occur in an on-axis surface space D5 between the first lens group GR1 and the second lens group GR2, an on-axis surface space D11 between the second lens group GR2 and the aperture stop S, an on-axis surface space D17 between the third lens group GR3 and the fourth lens group GR4, and an on-axis surface space D19 between the fourth lens group GR4 and the cover glass CG. Table 6 shows, together with the focal length f, the F number Fno, and the half angle of view ω, variable spaces of respective on-axis surface spaces at the wide-angle end state, the middle focal length state, and the telephoto end state in Numerical Example 2.

TABLE 6

| | Wide-Angle | Middle Focal | Telephoto |
|---|---|---|---|
| | End | Length | End |
| f | 4.80 | 15.54 | 51.67 |
| Fno | 2.89 | 3.81 | 4.66 |
| ω | 40.85 | 14.01 | 4.21 |
| D5 | 0.350 | 10.049 | 19.152 |
| D11 | 10.550 | 3.481 | 0.400 |
| D17 | 4.917 | 6.498 | 16.447 |
| D19 | 5.194 | 9.752 | 4.464 |

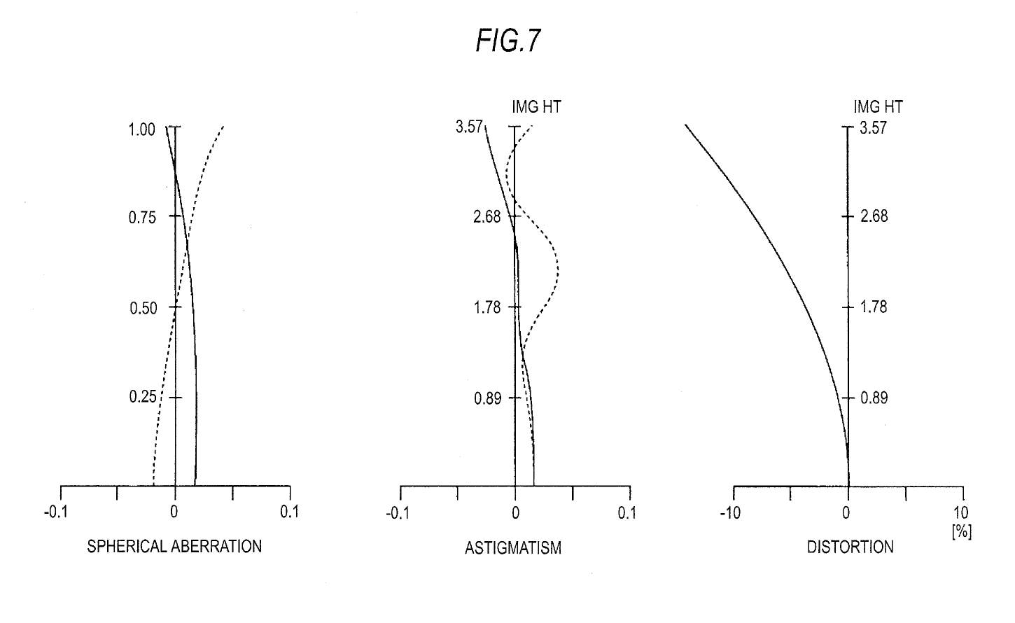

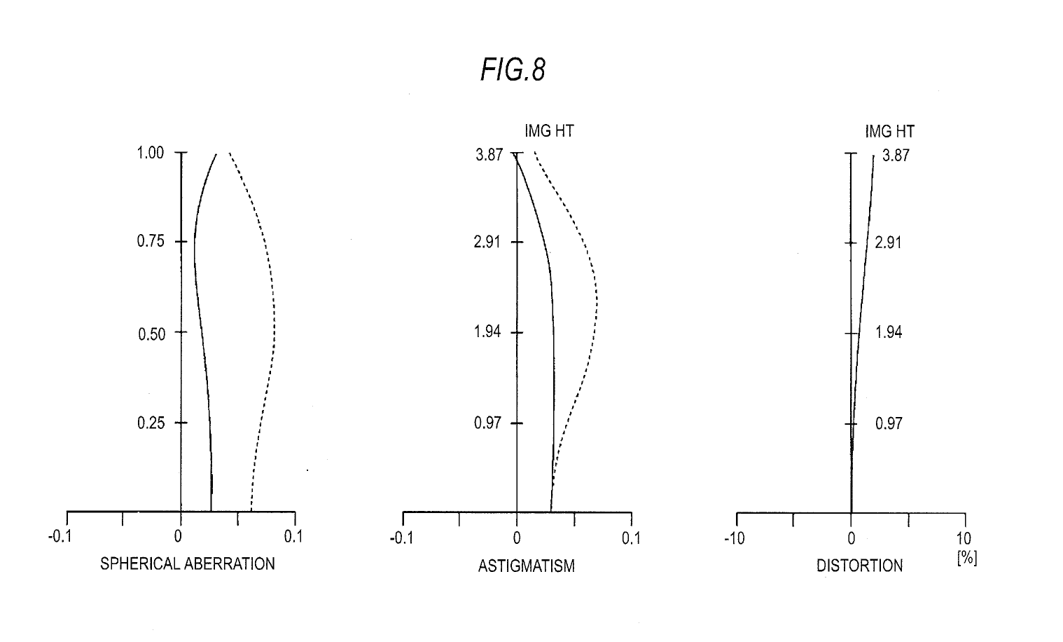

FIGS. 7 and 8 show diagrams of various aberrations in a state where the focus is at infinity in Numerical Example 2, where FIG. 7 shows a diagram of various aberrations at the wide-angle end state and FIG. 8 shows a diagram of various aberrations at the telephoto end state.

In each spherical aberration diagram of FIGS. 7 and 8, the solid line indicates the d-line (the wavelength of 587.6 nm), and the dashed line indicates the g-line (the wavelength of 435.8 nm). In each astigmatism diagram, the solid line indicates a value on the sagittal image plane, and the dashed line indicates a value on the meridional image plane.

As can be clearly seen from the aberration diagrams, in Numerical Example 2, it is possible to obtain excellent imaging performance by satisfactorily correcting various aberrations.

### Third Embodiment

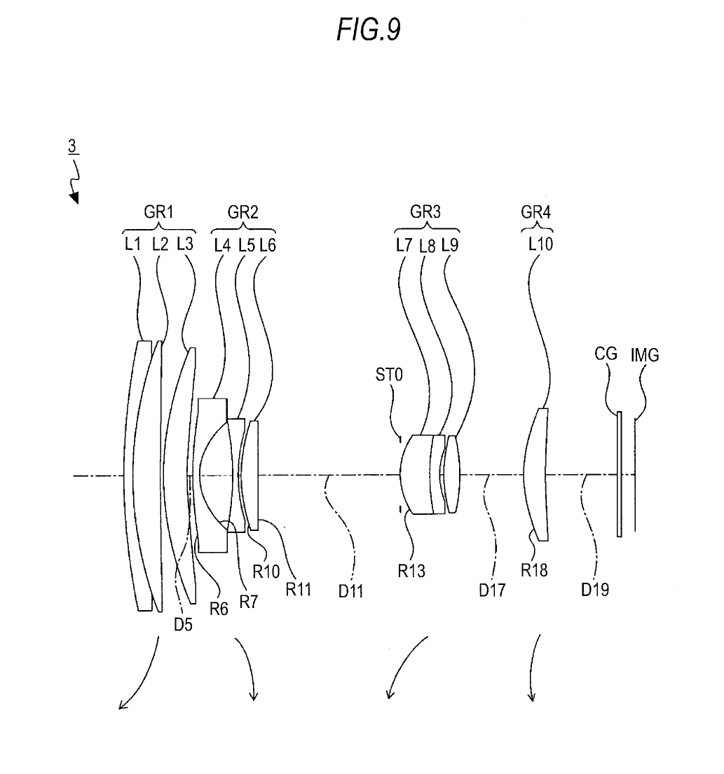

FIG. 9 shows a lens configuration of the zoom lens 3 according to the third embodiment of the present technology.

The zoom lens 3 includes, in order from the object side to the image side: a first lens group GR1 with a positive refractive power; a second lens group GR2 with a negative refractive power; a third lens group GR3 with a positive refractive power; and a fourth lens group GR4 with a positive refractive power.

The zoom lens 3 has a zoom ratio of 8.99 magnifications.

The first lens group GR1 includes, in order from the object side to the image side: a cemented lens that is formed by cementing a negative lens L1, which is convex toward the object side and has a meniscus shape, and a positive lens L2 which is convex toward the object side and has a meniscus shape; and a positive lens L3 which is convex toward the object side and has a meniscus shape.

The second lens group GR2 includes, in order from the object side to the image side: a first negative lens L4 that is convex toward the object side; a second negative lens L5 that has a biconcave shape; and a positive lens L6 that is convex toward the object side and has a meniscus shape.

The third lens group GR3 includes, in order from the object side to the image side: a cemented lens that is formed by cementing a positive lens L7, which is convex toward the object side and has a meniscus shape, and a negative lens L8 which is convex toward the object side; and a positive lens L9 that has a biconvex shape.

The fourth lens group GR4 includes a positive lens L10 that is convex toward the object side and has a meniscus shape.

A cover glass CG is disposed between the fourth lens group GR4 and an image plane IMG.

An aperture stop STO is disposed near the object side of the third lens group GR3 between the second lens group GR2 and the third lens group GR3, and is shifted integrally with the third lens group GR3 in the optical axis direction.

Table 7 shows the lens data of Numerical Example 3 of the zoom lens 3, to which specific numerical values are applied, according to the third embodiment.

TABLE 7

| Si | Ri | Di | ni | νi |
|---|---|---|---|---|
| 1 | 44.752 | 0.650 | 1.92286 | 20.880 |
| 2 | 27.201 | 2.081 | 1.59282 | 68.624 |
| 3 | 500.000 | 0.150 | | |
| 4 | 21.865 | 1.936 | 1.72916 | 54.674 |
| 5 | 74.276 | (D5) | | |
| 6(ASP) | 500.000 | 0.400 | 1.80139 | 45.450 |
| 7(ASP) | 5.456 | 2.469 | | |
| 8 | −24.500 | 0.450 | 1.80420 | 46.503 |
| 9 | 10.562 | 0.200 | | |
| 10(ASP) | 8.658 | 1.220 | 2.00170 | 19.324 |
| 11(ASP) | 25.974 | (D11) | | |
| 12(STO) | INFINITY | 0.000 | | |
| 13(ASP) | 4.680 | 2.200 | 1.68893 | 31.161 |
| 14 | 12.325 | 0.664 | 1.94595 | 17.980 |
| 15 | 4.886 | 0.334 | | |
| 16 | 10.443 | 1.218 | 1.61800 | 63.390 |
| 17 | −10.443 | (D17) | | |
| 18(ASP) | 10.714 | 1.528 | 1.49710 | 81.560 |
| 19 | 50.000 | (D19) | | |
| 20 | INFINITY | 0.300 | 1.51680 | 64.200 |
| 21 | INFINITY | 1.000 | | |
| 22(IMG) | INFINITY | | | |

In the zoom lens 3, both surfaces (sixth surface and seventh surface) of the first negative lens L4 of the second lens group GR2, both surfaces (tenth surface and eleventh surface) of the positive lens L6 of the second lens group GR2, the object side surface (thirteenth surface) of the positive lens L7 of the third lens group GR3, and the object side surface (eighteenth surface) of the positive lens L10 of the fourth lens group GR4 are formed as aspheric surfaces. Table 8 shows, together with the conic constant κ, the 4th-order, 6th-order, 8th-order, and 10th-order aspheric surface coefficients A, B, C, and D of the aspheric surfaces in Numerical Example 3.

TABLE 8

| Si | κ | A | B | C | D |
|---|---|---|---|---|---|
| 6 | 1.50000E+01 | 2.08023E−03 | −1.07706E−04 | 2.22078E−06 | −1.77981E−08 |
| 7 | 0.00000E+00 | 2.09407E−03 | 2.59388E−05 | 3.66545E−06 | −4.38066E−07 |
| 10 | 2.16289E+00 | −1.87614E−03 | 1.17258E−04 | −7.07145E−06 | 0.00000E+00 |
| 11 | 0.00000E+00 | −1.30268E−03 | 9.31696E−05 | −6.24858E−06 | 9.50005E−08 |
| 13 | 0.00000E+00 | −7.85330E−04 | −1.27914E−05 | −8.01349E−07 | 0.00000E+00 |
| 18 | 0.00000E+00 | −1.26701E−04 | 2.54232E−06 | 3.77171E−08 | −4.36322E−09 |

In the zoom lens 3, during the power variation between the wide-angle end state and the telephoto end state, changes occur in an on-axis surface space D5 between the first lens group GR1 and the second lens group GR2, an on-axis surface space D11 between the second lens group GR2 and the aperture stop S, an on-axis surface space D17 between the third lens group GR3 and the fourth lens group GR4, and an on-axis surface space D19 between the fourth lens group GR4 and the cover glass CG. Table 9 shows, together with the focal length f, the F number Fno, and the half angle of view ω, variable spaces of respective on-axis surface spaces at the wide-angle end state, the middle focal length state, and the telephoto end state in Numerical Example 3.

TABLE 9

| | Wide-Angle | Middle Focal | Telephoto |
|---|---|---|---|
| | End | Length | End |
| f | 4.81 | 14.33 | 43.19 |
| Fno | 2.88 | 3.73 | 4.49 |
| ω | 40.79 | 15.03 | 5.03 |
| D5 | 0.350 | 9.479 | 18.179 |
| D11 | 10.450 | 3.578 | 0.350 |
| D17 | 4.643 | 6.126 | 14.090 |
| D19 | 14.090 | 9.293 | 6.581 |

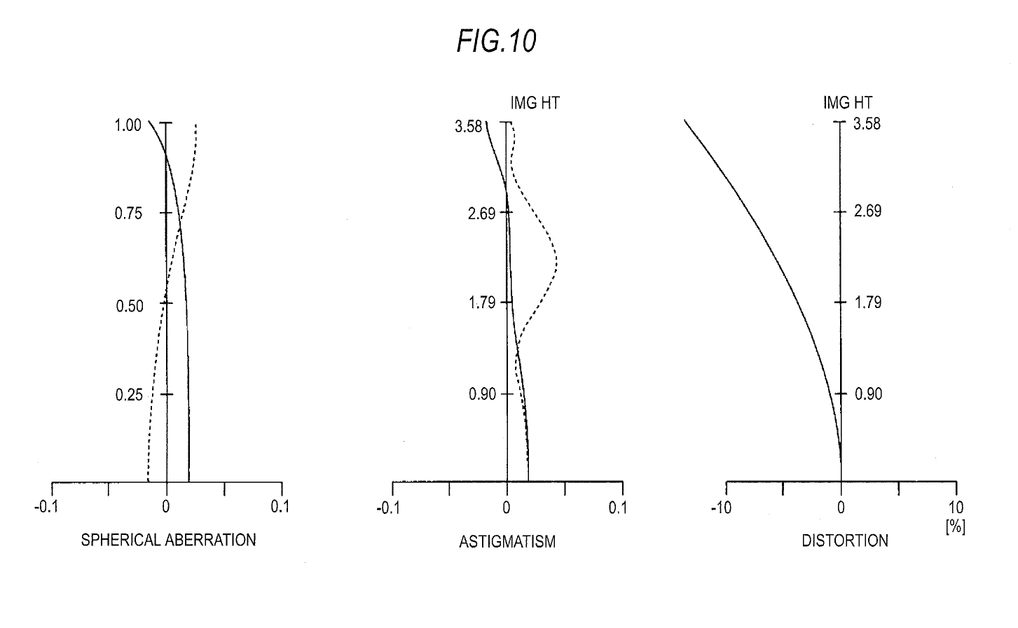

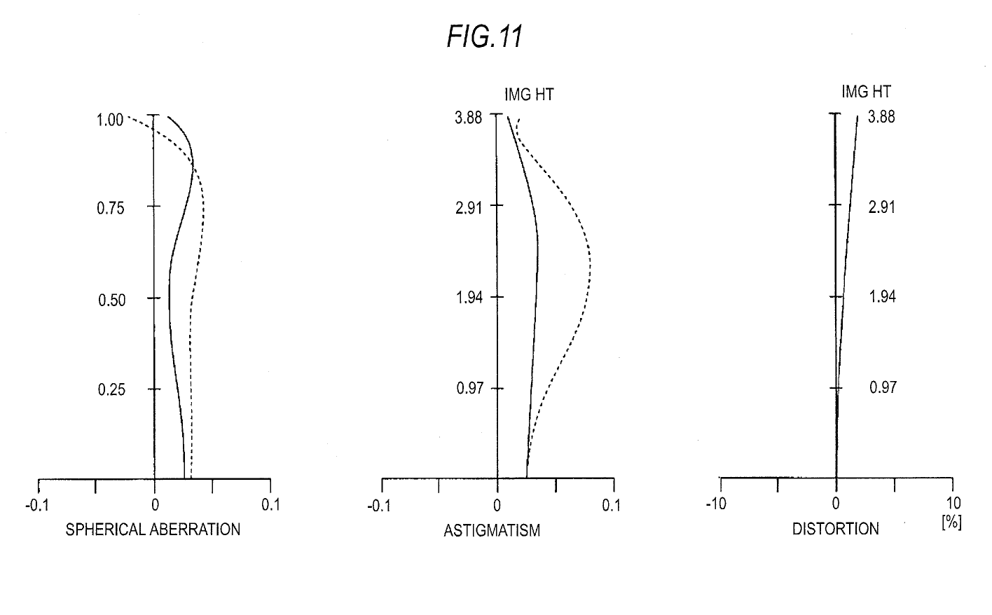

FIGS. 10 and 11 show diagrams of various aberrations in a state where the focus is at infinity in Numerical Example 3, where FIG. 10 shows a diagram of various aberrations at the wide-angle end state and FIG. 11 shows a diagram of various aberrations at the telephoto end state.

In each spherical aberration diagram of FIGS. 10 and 11, the solid line indicates the d-line (the wavelength of 587.6 nm), and the dashed line indicates the g-line (the wavelength of 435.8 nm). In each astigmatism diagram, the solid line indicates a value on the sagittal image plane, and the dashed line indicates a value on the meridional image plane.

As can be clearly seen from the aberration diagrams, in Numerical Example 3, it is possible to obtain excellent imaging performance by satisfactorily correcting various aberrations.

### Fourth Embodiment

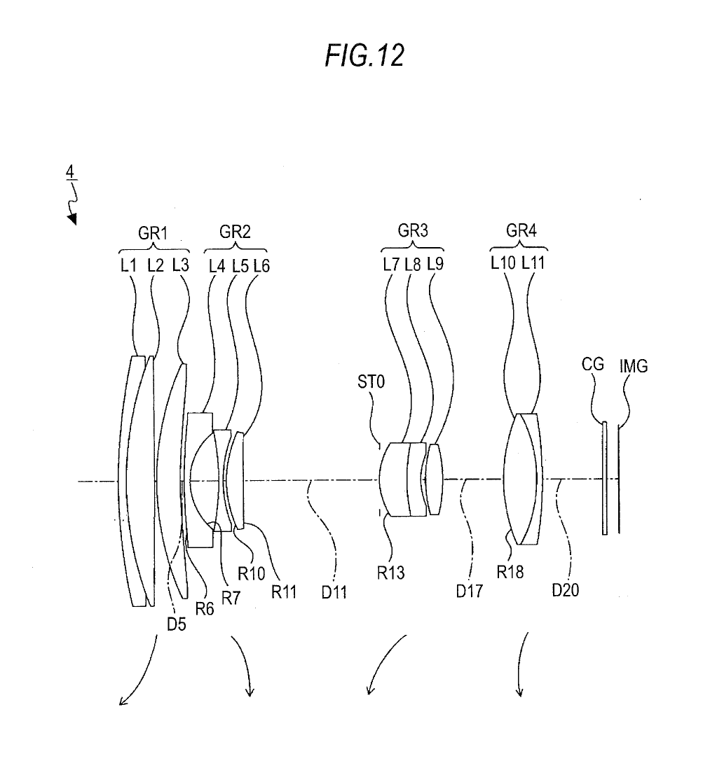

FIG. 12 shows a lens configuration of the zoom lens 4 according to the fourth embodiment of the present technology.

The zoom lens 4 includes, in order from the object side to the image side: a first lens group GR1 with a positive refractive power; a second lens group GR2 with a negative refractive power; a third lens group GR3 with a positive refractive power; and a fourth lens group GR4 with a positive refractive power.

The zoom lens 4 has a zoom ratio of 12.10 magnifications.

The first lens group GR1 includes, in order from the object side to the image side: a cemented lens that is formed by cementing a negative lens L1, which is convex toward the object side and has a meniscus shape, and a positive lens L2 which has a biconvex shape; and a positive lens L3 which is convex toward the object side and has a meniscus shape.

The second lens group GR2 includes, in order from the object side to the image side: a first negative lens L4 that is convex toward the object side; a second negative lens L5 that has a biconcave shape; and a positive lens L6 that is convex toward the object side and has a meniscus shape.

The third lens group GR3 includes, in order from the object side to the image side: a cemented lens that is formed by cementing a positive lens L7, which is convex toward the object side and has a meniscus shape, and a negative lens L8 which is convex toward the object side; and a positive lens L9 that has a biconvex shape.

The fourth lens group GR4 includes a cemented lens that is formed by cementing a positive lens L10, which has a biconvex shape, and a negative lens L11 which is concave toward the object side and has a meniscus shape.

A cover glass CG is disposed between the fourth lens group GR4 and an image plane IMG.

An aperture stop STO is disposed near the object side of the third lens group GR3 between the second lens group GR2 and the third lens group GR3, and is shifted integrally with the third lens group GR3 in the optical axis direction.

Table 10 shows the lens data of Numerical Example 4 of the zoom lens 4, to which specific numerical values are applied, according to the fourth embodiment.

TABLE 10

| Si | Ri | Di | ni | νi |
|---|---|---|---|---|
| 1 | 47.073 | 0.700 | 1.92286 | 20.880 |
| 2 | 28.018 | 2.398 | 1.59282 | 68.624 |
| 3 | −500.000 | 0.150 | | |
| 4 | 22.134 | 2.002 | 1.72916 | 54.674 |
| 5 | 63.245 | (D5) | | |
| 6(ASP) | 1000.000 | 0.400 | 1.82080 | 42.706 |
| 7(ASP) | 5.502 | 2.444 | | |
| 8 | −22.051 | 0.450 | 1.77250 | 49.624 |
| 9 | 9.913 | 0.200 | | |
| 10(ASP) | 8.130 | 1.320 | 2.00170 | 19.324 |
| 11(ASP) | 26.075 | (D11) | | |
| 12(STO) | INFINITY | 0.000 | | |
| 13(ASP) | 5.500 | 2.300 | 1.73077 | 40.501 |
| 14 | 14.257 | 1.200 | 1.92286 | 20.880 |
| 15 | 5.486 | 0.332 | | |
| 16 | 11.781 | 1.450 | 1.61800 | 63.390 |
| 17 | −11.781 | (D17) | | |
| 18(ASP) | 14.000 | 2.750 | 1.59201 | 67.023 |
| 19 | −11.593 | 0.403 | 1.83400 | 37.345 |
| 20 | −35.510 | (D20) | | |
| 21 | INFINITY | 0.300 | 1.51680 | 64.200 |
| 22 | INFINITY | 1.000 | | |
| 23(IMG) | INFINITY | | | |

In the zoom lens 4, both surfaces (sixth surface and seventh surface) of the first negative lens L4 of the second lens group GR2, both surfaces (tenth surface and eleventh surface) of the positive lens L6 of the second lens group GR2, the object side surface (thirteenth surface) of the positive lens L7 of the third lens group GR3, and the object side surface (eighteenth surface) of the positive lens L10 of the fourth lens group GR4 are formed as aspheric surfaces. Table 11 shows, together with the conic constant κ, the 4th-order, 6th-order, 8th-order, and 10th-order aspheric surface coefficients A, B, C, and D of the aspheric surfaces in Numerical Example 4.

TABLE 11

| Si | κ | A | B | C | D |
|---|---|---|---|---|---|
| 6 | 1.87205E−02 | 1.55504E−03 | −7.29196E−05 | 1.28058E−06 | −8.31451E−09 |
| 7 | 0.00000E+00 | 1.30772E−03 | 2.86290E−05 | 2.31795E−06 | −2.93456E−07 |
| 10 | 1.73116E+00 | −1.97692E−03 | 9.62052E−05 | −4.82959E−06 | 0.00000E+00 |
| 11 | 0.00000E+00 | −1.27685E−03 | 7.61710E−05 | −4.13526E−06 | 6.38951E−08 |
| 13 | 0.00000E+00 | −5.18358E−04 | −2.58894E−06 | −4.16072E−07 | 0.00000E+00 |
| 18 | 0.00000E+00 | −1.82970E−05 | 4.13564E−06 | −1.76244E−07 | 3.16433E−09 |

In the zoom lens 4, during the power variation between the wide-angle end state and the telephoto end state, changes occur in an on-axis surface space D5 between the first lens group GR1 and the second lens group GR2, an on-axis surface space D11 between the second lens group GR2 and the aperture stop S, an on-axis surface space D17 between the third lens group GR3 and the fourth lens group GR4, and an on-axis surface space D20 between the fourth lens group GR4 and the cover glass CG. Table 12 shows, together with the focal length f, the F number Fno, and the half angle of view w, variable spaces of respective on-axis surface spaces at the wide-angle end state, the middle focal length state, and the telephoto end state in Numerical Example 4.

TABLE 12

| | Wide-Angle | Middle Focal | Telephoto |
|---|---|---|---|
| | End | Length | End |
| f | 4.81 | 16.51 | 58.18 |
| Fno | 2.88 | 3.82 | 4.97 |
| ω | 40.46 | 13.10 | 3.73 |
| D5 | 0.350 | 10.674 | 19.600 |
| D11 | 11.400 | 3.550 | 0.400 |
| D17 | 5.132 | 8.251 | 20.563 |
| D20 | 5.143 | 10.122 | 5.213 |

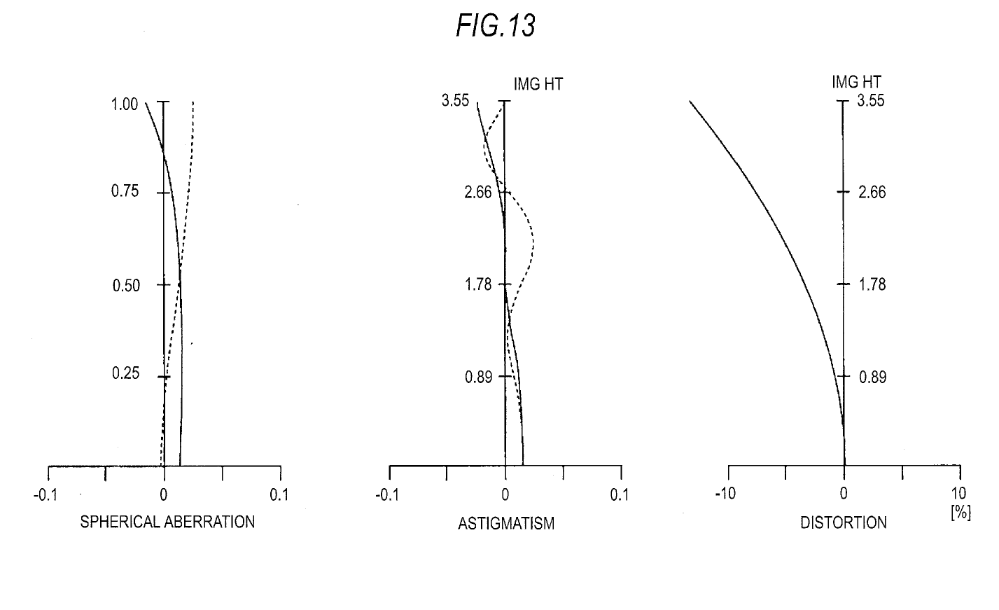

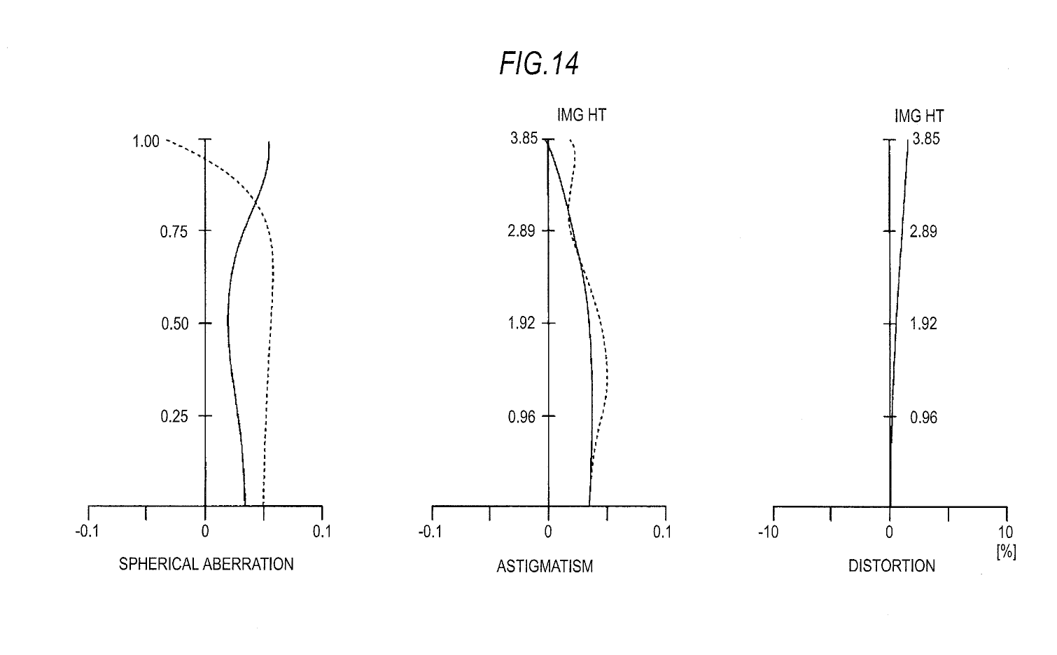

FIGS. 13 and 14 show diagrams of various aberrations in a state where the focus is at infinity in Numerical Example 4, where FIG. 13 shows a diagram of various aberrations at the wide-angle end state and FIG. 14 shows a diagram of various aberrations at the telephoto end state.

In each spherical aberration diagram of FIGS. 13 and 14, the solid line indicates the d-line (the wavelength of 587.6 nm), and the dashed line indicates the g-line (the wavelength of 435.8 nm). In each astigmatism diagram, the solid line indicates a value on the sagittal image plane, and the dashed line indicates a value on the meridional image plane.

As can be clearly seen from the aberration diagrams, in Numerical Example 4, it is possible to obtain excellent imaging performance by satisfactorily correcting various aberrations.

### Fifth Embodiment

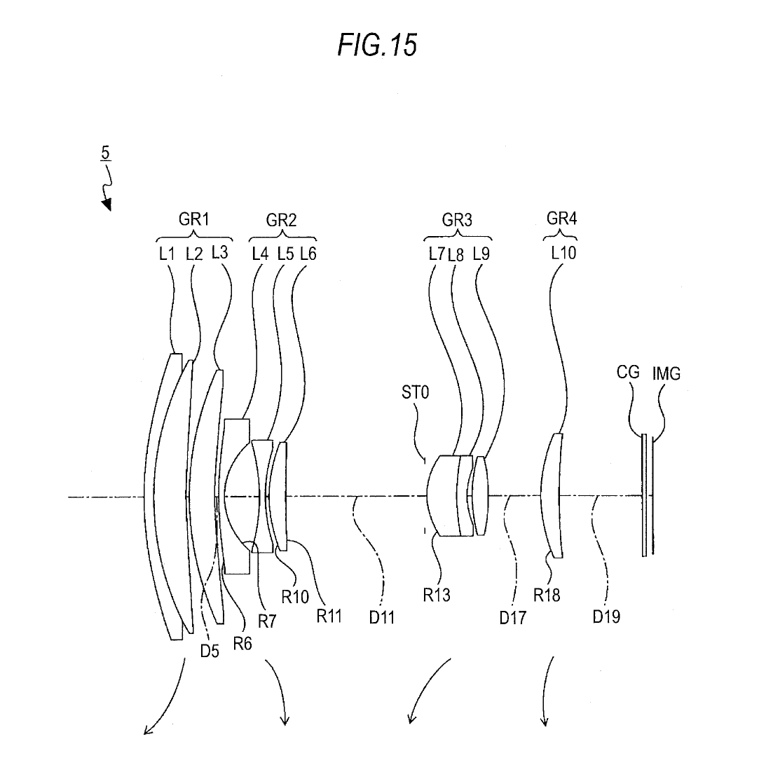

FIG. 15 shows a lens configuration of the zoom lens 5 according to the fifth embodiment of the present technology.

The zoom lens 5 includes, in order from the object side to the image side: a first lens group GR1 with a positive refractive power; a second lens group GR2 with a negative refractive power; a third lens group GR3 with a positive refractive power; and a fourth lens group GR4 with a positive refractive power.

The zoom lens 5 has a zoom ratio of 9.23 magnifications.

The first lens group GR1 includes, in order from the object side to the image side: a cemented lens that is formed by cementing a negative lens L1, which is convex toward the object side and has a meniscus shape, and a positive lens L2 which is convex toward the object side and has a meniscus shape; and a positive lens L3 which is convex toward the object side and has a meniscus shape.

The second lens group GR2 includes, in order from the object side to the image side: a first negative lens L4 that is convex toward the object side; a second negative lens L5 that has a biconcave shape; and a positive lens L6 that is convex toward the object side and has a meniscus shape.

The third lens group GR3 includes, in order from the object side to the image side: a cemented lens that is formed by cementing a positive lens L7, which is convex toward the object side and has a meniscus shape, and a negative lens L8 which is convex toward the object side; and a positive lens L9 that has a biconvex shape.

The fourth lens group GR4 includes a positive lens L10 that is convex toward the object side and has a meniscus shape.

A cover glass CG is disposed between the fourth lens group GR4 and an image plane IMG.

An aperture stop STO is disposed near the object side of the third lens group GR3 between the second lens group GR2 and the third lens group GR3, and is shifted integrally with the third lens group GR3 in the optical axis direction.

Table 13 shows the lens data of Numerical Example 5 of the zoom lens 5, to which specific numerical values are applied, according to the fifth embodiment.

TABLE 13

| Si | Ri | Di | ni | νi |
|---|---|---|---|---|
| 1 | 28.000 | 0.800 | 1.94595 | 17.980 |
| 2 | 21.253 | 2.515 | 1.59282 | 68.624 |
| 3 | 93.527 | 0.150 | | |
| 4 | 22.500 | 1.998 | 1.72916 | 54.674 |
| 5 | 59.914 | (D5) | | |
| 6(ASP) | 100.000 | 0.400 | 1.85135 | 40.100 |
| 7(ASP) | 6.000 | 2.654 | | |
| 8 | −15.000 | 0.450 | 1.80420 | 46.503 |
| 9 | 10.350 | 0.300 | | |
| 10(ASP) | 9.200 | 1.313 | 2.00170 | 19.324 |
| 11(ASP) | 51.256 | (D11) | | |
| 12(STO) | INFINITY | 0.150 | | |
| 13(ASP) | 4.824 | 2.234 | 1.68893 | 31.161 |
| 14 | 13.959 | 0.800 | 1.94595 | 17.980 |
| 15 | 5.033 | 0.356 | | |
| 16 | 10.445 | 1.251 | 1.61800 | 63.390 |
| 17 | −10.445 | (D17) | | |
| 18(ASP) | 10.800 | 1.429 | 1.49710 | 81.560 |
| 19 | 52.228 | (D19) | | |
| 20 | INFINITY | 0.300 | 1.51680 | 64.200 |
| 21 | INFINITY | 0.500 | | |
| 22(IMG) | INFINITY | | | |

In the zoom lens 5, both surfaces (sixth surface and seventh surface) of the first negative lens L4 of the second lens group GR2, both surfaces (tenth surface and eleventh surface) of the positive lens L6 of the second lens group GR2, the object side surface (thirteenth surface) of the positive lens L7 of the third lens group GR3, and the object side surface (eighteenth surface) of the positive lens L10 of the fourth lens group GR4 are formed as aspheric surfaces. Table 14 shows, together with the conic constant κ, the 4th-order, 6th-order, 8th-order, and 10th-order aspheric surface coefficients A, B, C, and D of the aspheric surfaces in Numerical Example 5.

TABLE 14

| Si | κ | A | B | C | D |
|---|---|---|---|---|---|
| 6 | 0.00000E+00 | 1.43166E−03 | −5.16582E−05 | 5.21529E−07 | 1.35180E−10 |
| 7 | 0.00000E+00 | 1.42374E−03 | 2.37299E−05 | 3.20106E−06 | −3.21331E−07 |
| 10 | 0.00000E+00 | −1.01132E−03 | 1.14984E−04 | −1.04541 E−05 | 3.26155E−07 |
| 11 | 0.00000E+00 | −7.67005E−04 | 8.76640E−05 | −9.05423E−06 | 3.37169E−07 |
| 13 | 0.00000E+00 | −7.24286E−04 | −2.04952E−05 | 1.56156E−06 | −1.47836E−07 |
| 18 | 0.00000E+00 | −1.32951E−04 | 5.38044E−06 | −4.97839E−08 | −3.64546E−09 |

In the zoom lens 5, during the power variation between the wide-angle end state and the telephoto end state, changes occur in an on-axis surface space D5 between the first lens group GR1 and the second lens group GR2, an on-axis surface space D11 between the second lens group GR2 and the aperture stop S, an on-axis surface space D17 between the third lens group GR3 and the fourth lens group GR4, and an on-axis surface space D19 between the fourth lens group GR4 and the cover glass CG. Table 15 shows, together with the focal length f, the F number Fno, and the half angle of view ω, variable spaces of respective on-axis surface spaces at the wide-angle end state, the middle focal length state, and the telephoto end state in Numerical Example 5.

TABLE 15

| | Wide-Angle | Middle Focal | Telephoto |
|---|---|---|---|
| | End | Length | End |
| f | 4.79 | 14.54 | 44.15 |
| Fno | 2.69 | 3.61 | 3.95 |
| ω | 40.92 | 14.97 | 4.92 |
| D5 | 0.300 | 8.248 | 18.067 |
| D11 | 10.500 | 3.043 | 0.400 |
| D17 | 4.005 | 5.807 | 13.150 |
| D19 | 6.243 | 10.634 | 5.449 |

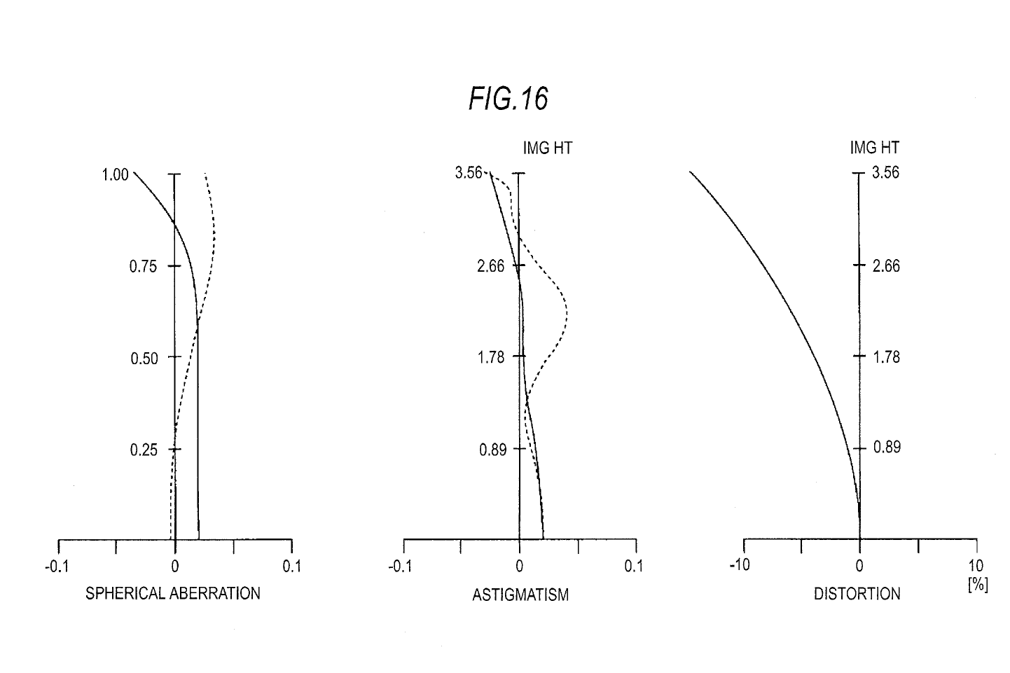

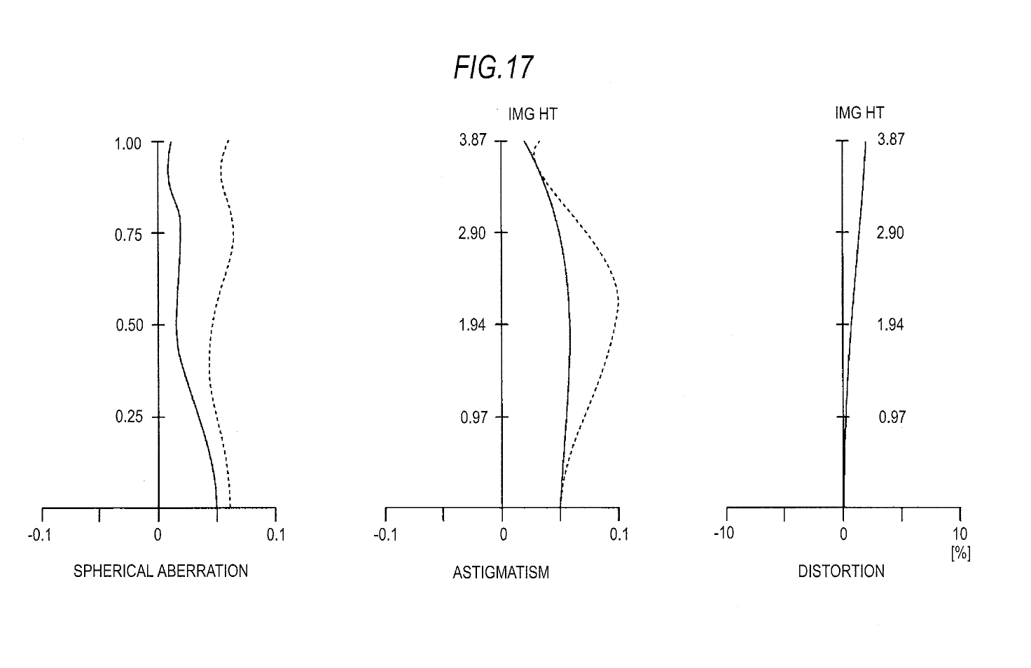

FIGS. 16 and 17 show diagrams of various aberrations in a state where the focus is at infinity in Numerical Example 5, where FIG. 16 shows a diagram of various aberrations at the wide-angle end state and FIG. 17 shows a diagram of various aberrations at the telephoto end state.

In each spherical aberration diagram of FIGS. 16 and 17, the solid line indicates the d-line (the wavelength of 587.6 nm), and the dashed line indicates the g-line (the wavelength of 435.8 nm). In each astigmatism diagram, the solid line indicates a value on the sagittal image plane, and the dashed line indicates a value on the meridional image plane.

As can be clearly seen from the aberration diagrams, in Numerical Example 5, it is possible to obtain excellent imaging performance by satisfactorily correcting various aberrations.

### Sixth Embodiment

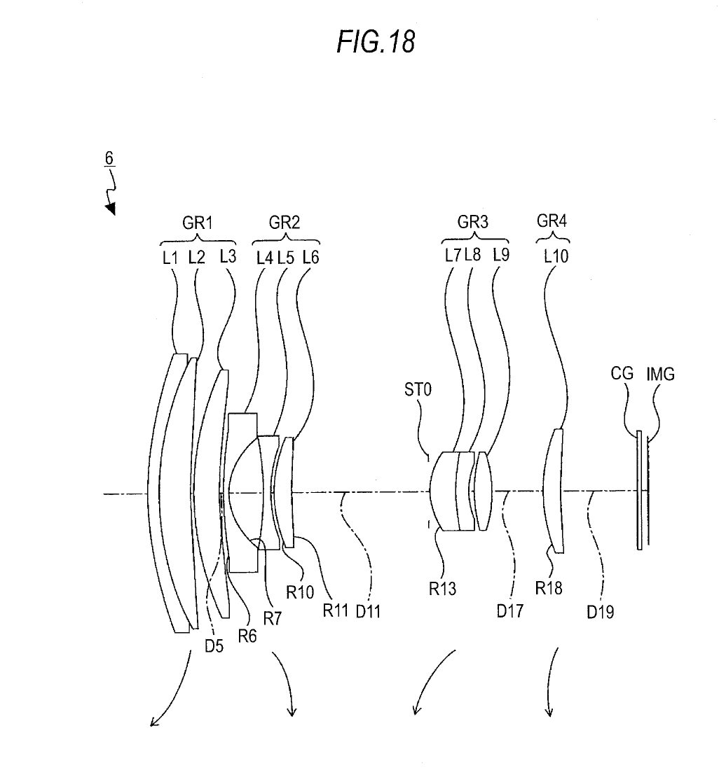

FIG. 18 shows a lens configuration of the zoom lens 6 according to the sixth embodiment of the present technology.

The zoom lens 6 includes, in order from the object side to the image side: a first lens group GR1 with a positive refractive power; a second lens group GR2 with a negative refractive power; a third lens group GR3 with a positive refractive power; and a fourth lens group GR4 with a positive refractive power.

The zoom lens 6 has a zoom ratio of 9.15 magnifications.

The first lens group GR1 includes, in order from the object side to the image side: a cemented lens that is formed by cementing a negative lens L1, which is convex toward the object side and has a meniscus shape, and a positive lens L2 which is convex toward the object side and has a meniscus shape; and a positive lens L3 which is convex toward the object side and has a meniscus shape.

The second lens group GR2 includes, in order from the object side to the image side: a first negative lens L4 that is convex toward the object side; a second negative lens L5 that has a biconcave shape; and a positive lens L6 that is convex toward the object side and has a meniscus shape.

The third lens group GR3 includes, in order from the object side to the image side: a cemented lens that is formed by cementing a positive lens L7, which is convex toward the object side and has a meniscus shape, and a negative lens L8 which is convex toward the object side; and a positive lens L9 that has a biconvex shape.

The fourth lens group GR4 includes a positive lens L10 that is convex toward the object side and has a meniscus shape.

A cover glass CG is disposed between the fourth lens group GR4 and an image plane IMG.

An aperture stop STO is disposed near the object side of the third lens group GR3 between the second lens group GR2 and the third lens group GR3, and is shifted integrally with the third lens group GR3 in the optical axis direction.

Table 16 shows the lens data of Numerical Example 6 of the zoom lens 6, to which specific numerical values are applied, according to the sixth embodiment.

TABLE 16

| Si | Ri | Di | ni | νi |
|---|---|---|---|---|
| 1 | 28.000 | 0.800 | 1.94595 | 17.980 |
| 2 | 21.370 | 2.530 | 1.59282 | 68.624 |
| 3 | 98.571 | 0.150 | | |
| 4 | 22.500 | 2.000 | 1.72916 | 54.674 |
| 5 | 57.475 | (D5) | | |
| 6(ASP) | 300.000 | 0.400 | 1.85135 | 40.100 |
| 7(ASP) | 5.640 | 2.740 | | |
| 8 | −20.000 | 0.450 | 1.80420 | 46.503 |
| 9 | 9.719 | 0.300 | | |
| 10(ASP) | 9.200 | 1.337 | 2.00170 | 19.324 |
| 11(ASP) | 51.333 | (D11) | | |
| 12(STO) | INFINITY | 0.100 | | |
| 13(ASP) | 4.760 | 1.950 | 1.68893 | 31.161 |
| 14 | 15.888 | 1.100 | 1.94595 | 17.980 |
| 15 | 5.036 | 0.329 | | |
| 16 | 10.645 | 1.255 | 1.61800 | 63.390 |
| 17 | −9.628 | (D17) | | |
| 18(ASP) | 10.768 | 1.409 | 1.49710 | 81.560 |
| 19 | 50.000 | (D19) | | |
| 20 | INFINITY | 0.300 | 1.51680 | 64.200 |
| 21 | INFINITY | 0.500 | | |
| 22(IMG) | INFINITY | | | |

In the zoom lens 6, both surfaces (sixth surface and seventh surface) of the first negative lens L4 of the second lens group GR2, both surfaces (tenth surface and eleventh surface) of the positive lens L6 of the second lens group GR2, the object side surface (thirteenth surface) of the positive lens L7 of the third lens group GR3, and the object side surface (eighteenth surface) of the positive lens L10 of the fourth lens group GR4 are formed as aspheric surfaces. Table 17 shows, together with the conic constant κ, the 4th-order, 6th-order, 8th-order, and 10th-order aspheric surface coefficients A, B, C, and D of the aspheric surfaces in Numerical Example 6.

TABLE 17

| Si | κ | A | B | C | D |
|---|---|---|---|---|---|
| 6 | −1.44098E−11 | 2.09061E−03 | −9.93476E−05 | 1.94293E−06 | −1.50084E−08 |
| 7 | −5.39689E−01 | 2.49611E−03 | 3.42132E−05 | 3.40968E−06 | −3.75126E−07 |
| 10 | 2.30219E+00 | −1.35019E−03 | 1.13570E−04 | −5.84635E−06 | 0.00000E+00 |
| 11 | −4.00000E+01 | −8.38549E−04 | 9.67591E−05 | −4.95891E−06 | 5.55165E−08 |
| 13 | 0.00000E+00 | −8.69117E−04 | 6.39535E−06 | −2.60817E−06 | 6.30554E−08 |
| 18 | 0.00000E+00 | −1.41906E−04 | 5.35969E−06 | −1.15072E−07 | −1.60472E−09 |

In the zoom lens 6, during the power variation between the wide-angle end state and the telephoto end state, changes occur in an on-axis surface space D5 between the first lens group GR1 and the second lens group GR2, an on-axis surface space D11 between the second lens group GR2 and the aperture stop S, an on-axis surface space D17 between the third lens group GR3 and the fourth lens group GR4, and an on-axis surface space D19 between the fourth lens group GR4 and the cover glass CG. Table 18 shows, together with the focal length f, the F number Fno, and the half angle of view w, variable spaces of respective on-axis surface spaces at the wide-angle end state, the middle focal length state, and the telephoto end state in Numerical Example 6.

TABLE 18

| | Wide-Angle | Middle Focal | Telephoto |
|---|---|---|---|
| | End | Length | End |
| f | 4.47 | 13.50 | 40.80 |
| Fno | 2.65 | 3.47 | 4.02 |
| ω | 42.73 | 15.99 | 5.32 |
| D5 | 0.300 | 8.796 | 17.812 |
| D11 | 10.482 | 3.268 | 0.400 |
| D17 | 3.988 | 5.808 | 12.955 |
| D19 | 5.796 | 9.465 | 5.809 |

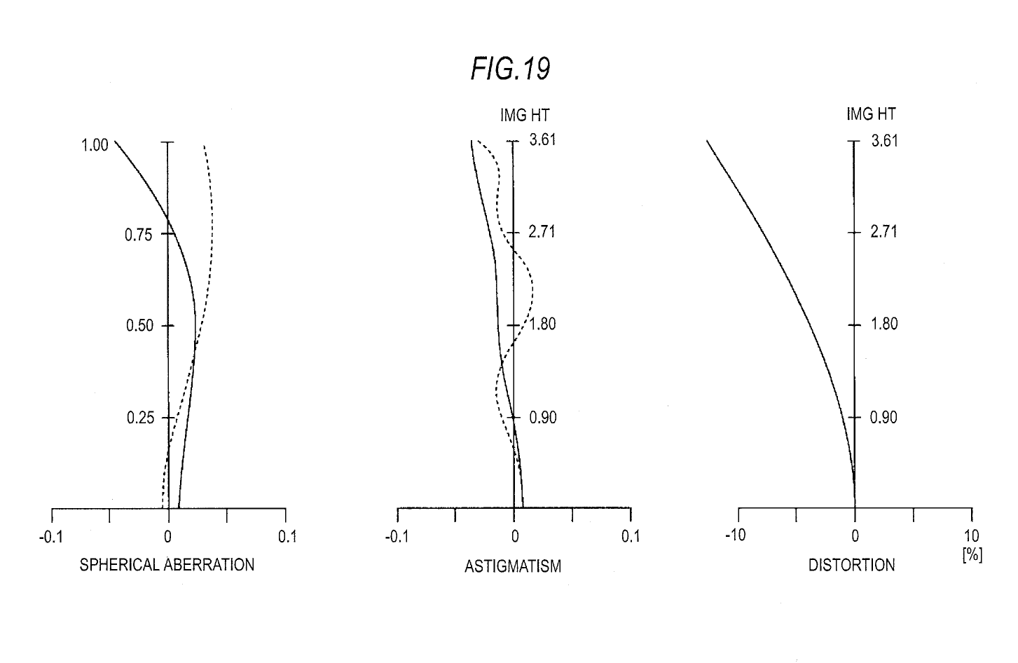

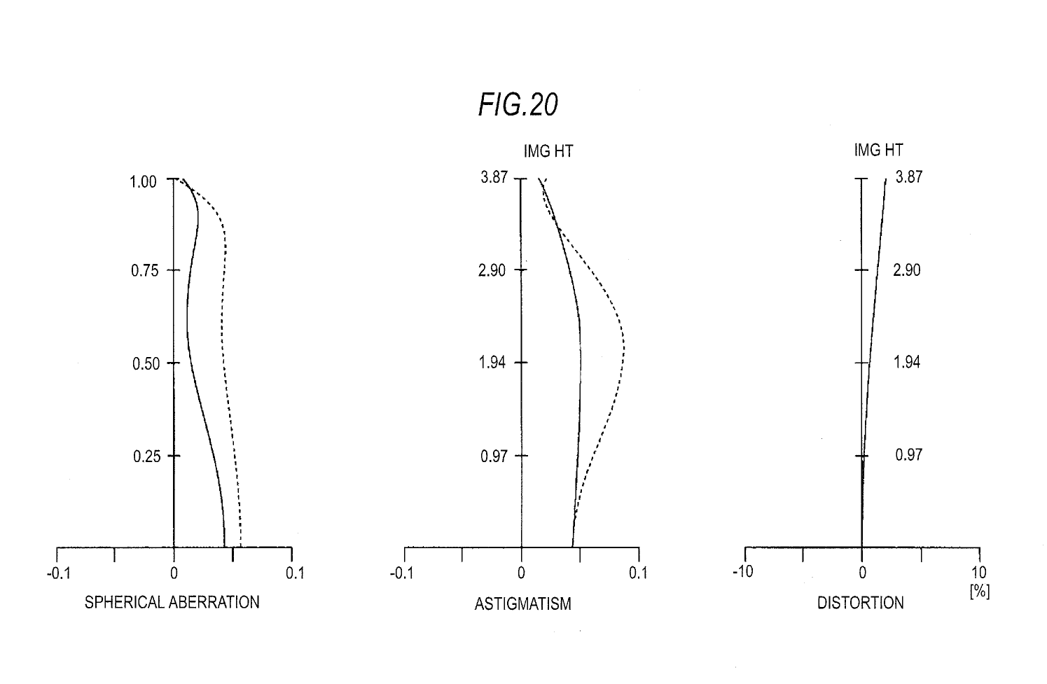

FIGS. 19 and 20 show diagrams of various aberrations in a state where the focus is at infinity in Numerical Example 6, where FIG. 19 shows a diagram of various aberrations at the wide-angle end state and FIG. 20 shows a diagram of various aberrations at the telephoto end state.

In each spherical aberration diagram of FIGS. 19 and 20, the solid line indicates the d-line (the wavelength of 587.6 nm), and the dashed line indicates the g-line (the wavelength of 435.8 nm). In each astigmatism diagram, the solid line indicates a value on the sagittal image plane, and the dashed line indicates a value on the meridional image plane.

As can be clearly seen from the aberration diagrams, in Numerical Example 6, it is possible to obtain excellent imaging performance by satisfactorily correcting various aberrations.

### Seventh Embodiment

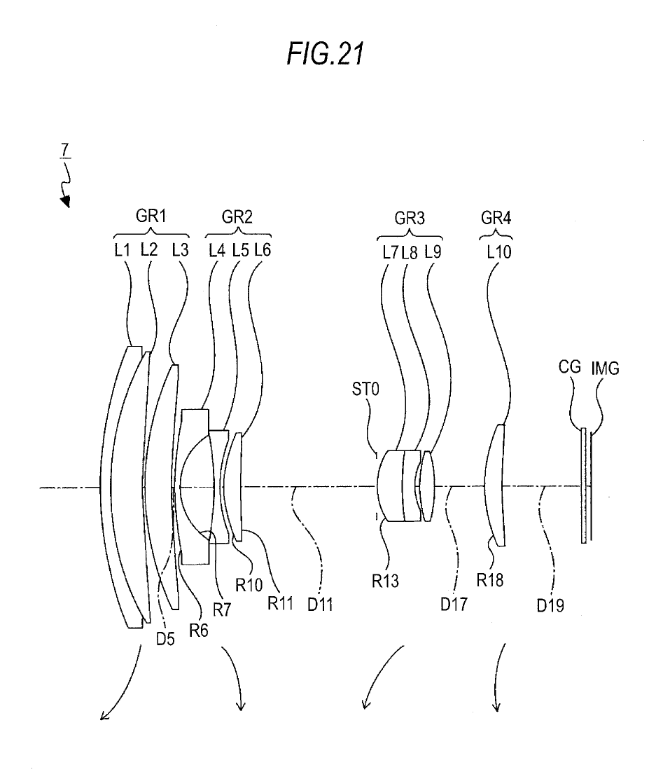

FIG. 21 shows a lens configuration of the zoom lens 7 according to the seventh embodiment of the present technology.

The zoom lens 7 includes, in order from the object side to the image side: a first lens group GR1 with a positive refractive power; a second lens group GR2 with a negative refractive power; a third lens group GR3 with a positive refractive power; and a fourth lens group GR4 with a positive refractive power.

The zoom lens 7 has a zoom ratio of 11.04 magnifications.

The first lens group GR1 includes, in order from the object side to the image side: a cemented lens that is formed by cementing a negative lens L1, which is convex toward the object side and has a meniscus shape, and a positive lens L2 which is convex toward the object side and has a meniscus shape; and a positive lens L3 which is convex toward the object side and has a meniscus shape.

The second lens group GR2 includes, in order from the object side to the image side: a first negative lens L4 that is convex toward the object side; a second negative lens L5 that has a biconcave shape; and a positive lens L6 that is convex toward the object side and has a meniscus shape.

The third lens group GR3 includes, in order from the object side to the image side: a cemented lens that is formed by cementing a positive lens L7, which is convex toward the object side and has a meniscus shape, and a negative lens L8 which is convex toward the object side; and a positive lens L9 that has a biconvex shape.

The fourth lens group GR4 includes a positive lens L10 that is convex toward the object side and has a meniscus shape.

A cover glass CG is disposed between the fourth lens group GR4 and an image plane IMG.

An aperture stop STO is disposed near the object side of the third lens group GR3 between the second lens group GR2 and the third lens group GR3, and is shifted integrally with the third lens group GR3 in the optical axis direction.

Table 19 shows the lens data of Numerical Example 7 of the zoom lens 7, to which specific numerical values are applied, according to the seventh embodiment.

TABLE 19

| Si | Ri | Di | ni | νi |
|---|---|---|---|---|
| 1 | 29.475 | 0.800 | 1.92286 | 20.880 |
| 2 | 20.982 | 2.600 | 1.59282 | 68.624 |
| 3 | 94.060 | 0.150 | | |
| 4 | 22.613 | 2.043 | 1.72916 | 54.674 |
| 5 | 62.845 | (D5) | | |
| 6(ASP) | 142.903 | 0.400 | 1.85135 | 40.100 |
| 7(ASP) | 5.454 | 2.717 | | |
| 8 | −20.000 | 0.450 | 1.80420 | 46.503 |
| 9 | 9.500 | 0.300 | | |
| 10(ASP) | 8.700 | 1.328 | 2.00170 | 19.324 |
| 11(ASP) | 39.965 | (D11) | | |
| 12(STO) | INFINITY | 0.100 | | |
| 13(ASP) | 4.800 | 2.000 | 1.68893 | 31.161 |
| 14 | 15.061 | 1.100 | 1.94595 | 17.980 |
| 15 | 5.031 | 0.298 | | |
| 16 | 10.600 | 1.183 | 1.61800 | 63.390 |
| 17 | −10.040 | (D17) | | |
| 18(ASP) | 10.769 | 1.432 | 1.49710 | 81.560 |
| 19 | 50.000 | (D19) | | |
| 20 | INFINITY | 0.300 | 1.51680 | 64.200 |
| 21 | INFINITY | 0.500 | | |
| 22(IMG) | INFINITY | | | |

In the zoom lens 7, both surfaces (sixth surface and seventh surface) of the first negative lens L4 of the second lens group GR2, both surfaces (tenth surface and eleventh surface) of the positive lens L6 of the second lens group GR2, the object side surface (thirteenth surface) of the positive lens L7 of the third lens group GR3, and the object side surface (eighteenth surface) of the positive lens L10 of the fourth lens group GR4 are formed as aspheric surfaces. Table 20 shows, together with the conic constant κ, the 4th-order, 6th-order, 8th-order, and 10th-order aspheric surface coefficients A, B, C, and D of the aspheric surfaces in Numerical Example 7.

TABLE 20

| Si | κ | A | B | C | D |
|---|---|---|---|---|---|
| 6 | 6.00000E+01 | 2.02544E−03 | −9.85364E−05 | 1.98082E−06 | −1.58071E−08 |
| 7 | −6.11880E−01 | 2.48517E−03 | 4.55810E−05 | 1.75220E−06 | −2.97603E−07 |
| 10 | 2.95318E+00 | −1.64254E−03 | 1.02029E−04 | −6.63948E−06 | 0.00000E+00 |
| 11 | 9.80000E+01 | −1.11490E−03 | 8.88556E−05 | −5.60528E−06 | 6.73956E−08 |
| 13 | 5.46737E−02 | −8.70155E−04 | −1.49735E−06 | −1.75331E−06 | 0.00000E+00 |
| 18 | 0.00000E+00 | −1.26644E−04 | 3.83593E−06 | −4.47527E−08 | −1.86553E−09 |

In the zoom lens 7, during the power variation between the wide-angle end state and the telephoto end state, changes occur in an on-axis surface space D5 between the first lens group GR1 and the second lens group GR2, an on-axis surface space D11 between the second lens group GR2 and the aperture stop S, an on-axis surface space D17 between the third lens group GR3 and the fourth lens group GR4, and an on-axis surface space D19 between the fourth lens group GR4 and the cover glass CG. Table 21 shows, together with the focal length f, the F number Fno, and the half angle of view ω, variable spaces of respective on-axis surface spaces at the wide-angle end state, the middle focal length state, and the telephoto end state in Numerical Example 7.

TABLE 21

| | Wide-Angle | Middle Focal | Telephoto |
|---|---|---|---|
| | End | Length | End |
| f | 4.44 | 14.75 | 49.00 |
| Fno | 2.90 | 3.92 | 4.72 |
| ω | 42.91 | 14.70 | 4.43 |
| D5 | 0.300 | 10.048 | 19.437 |
| D11 | 10.700 | 3.268 | 0.400 |
| D17 | 3.987 | 5.808 | 15.492 |
| D19 | 6.143 | 10.558 | 10.558 |

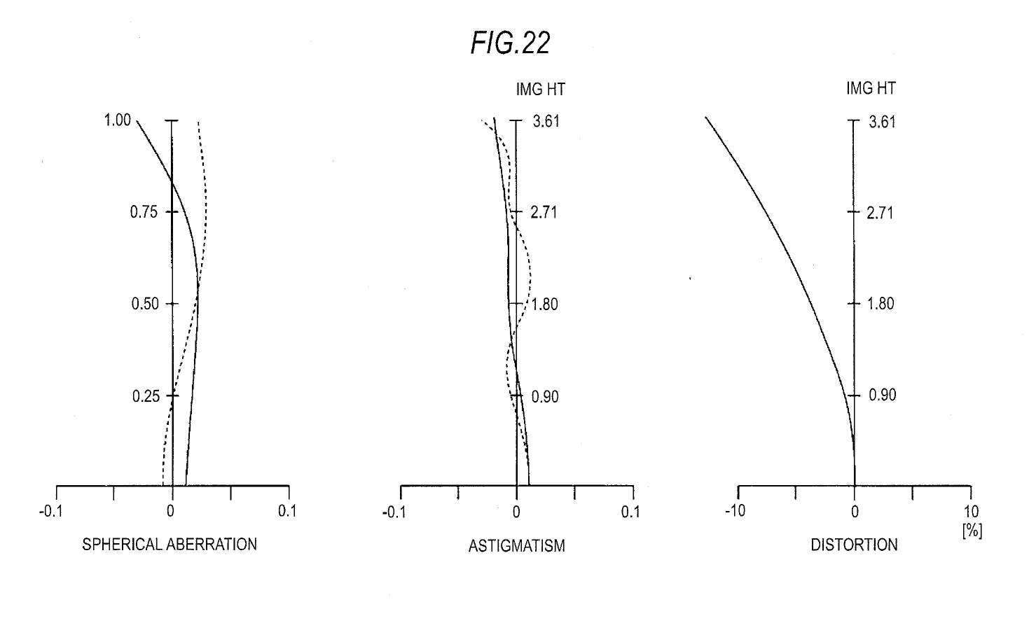

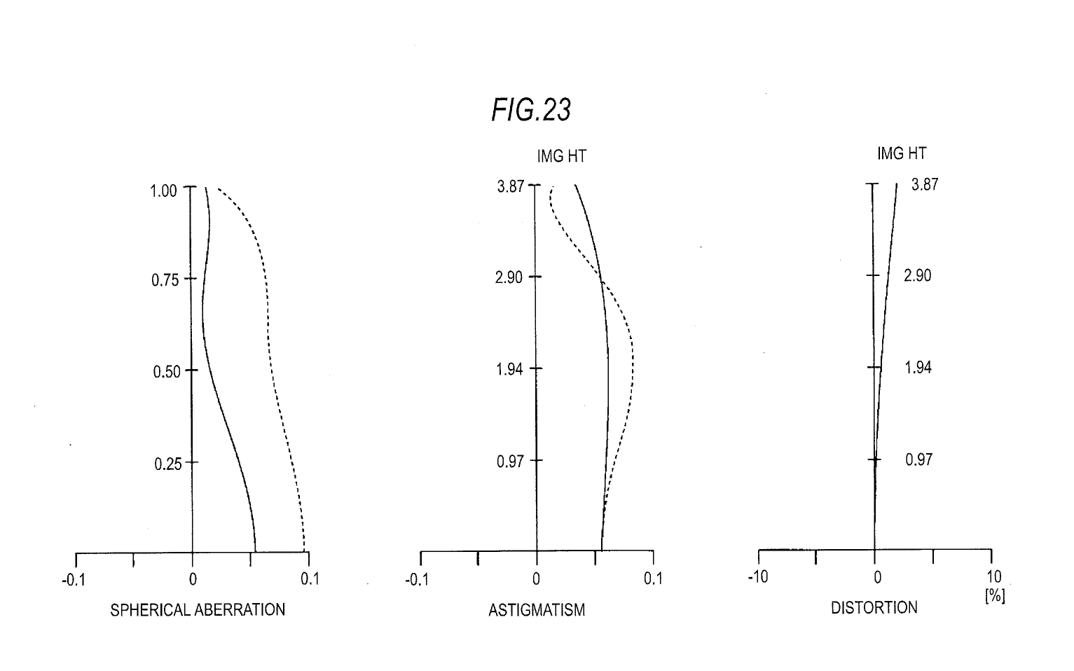

FIGS. 22 and 23 show diagrams of various aberrations in a state where the focus is at infinity in Numerical Example 7, where FIG. 22 shows a diagram of various aberrations at the wide-angle end state and FIG. 23 shows a diagram of various aberrations at the telephoto end state.

In each spherical aberration diagram of FIGS. 22 and 23, the solid line indicates the d-line (the wavelength of 587.6 nm), and the dashed line indicates the g-line (the wavelength of 435.8 nm). In each astigmatism diagram, the solid line indicates a value on the sagittal image plane, and the dashed line indicates a value on the meridional image plane.

As can be clearly seen from the aberration diagrams, in Numerical Example 7, it is possible to obtain excellent imaging performance by satisfactorily correcting various aberrations.

### Eighth Embodiment

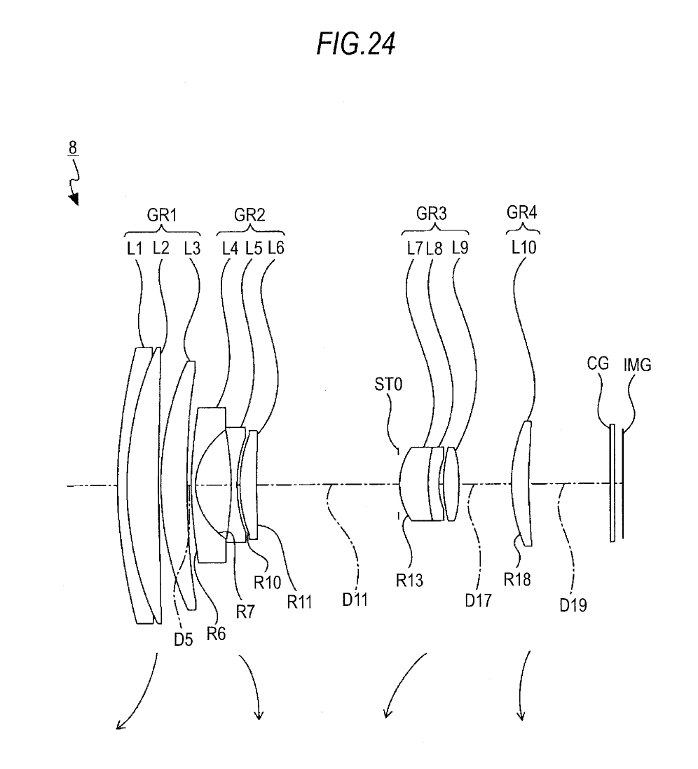

FIG. 24 shows a lens configuration of the zoom lens 8 according to the eighth embodiment of the present technology.

The zoom lens 8 includes, in order from the object side to the image side: a first lens group GR1 with a positive refractive power; a second lens group GR2 with a negative refractive power; a third lens group GR3 with a positive refractive power; and a fourth lens group GR4 with a positive refractive power.

The zoom lens 8 has a zoom ratio of 11.03 magnifications. The first lens group GR1 includes, in order from the object side to the image side: a cemented lens that is formed by cementing a negative lens L1, which is convex toward the object side and has a meniscus shape, and a positive lens L2 which is convex toward the object side and has a meniscus shape; and a positive lens L3 which is convex toward the object side and has a meniscus shape.

The second lens group GR2 includes, in order from the object side to the image side: a first negative lens L4 that is convex toward the object side and has a meniscus shape; a second negative lens L5 that has a biconcave shape; and a positive lens L6 that is convex toward the object side and has a meniscus shape.

The third lens group GR3 includes, in order from the object side to the image side: a cemented lens that is formed by cementing a positive lens L7, which is convex toward the object side and has a meniscus shape, and a negative lens L8 which is convex toward the object side; and a positive lens L9 that has a biconvex shape.

The fourth lens group GR4 includes a positive lens L10 that is convex toward the object side and has a meniscus shape.

A cover glass CG is disposed between the fourth lens group GR4 and an image plane IMG.

An aperture stop STO is disposed near the object side of the third lens group GR3 between the second lens group GR2 and the third lens group GR3, and is shifted integrally with the third lens group GR3 in the optical axis direction.

Table 22 shows the lens data of Numerical Example 8 of the zoom lens 8, to which specific numerical values are applied, according to the eighth embodiment.

TABLE 22

| Si | Ri | Di | ni | νi |
|---|---|---|---|---|
| 1 | 38.120 | 0.800 | 1.92286 | 20.880 |
| 2 | 24.810 | 2.440 | 1.59282 | 68.624 |
| 3 | 193.835 | 0.150 | | |
| 4 | 22.426 | 2.073 | 1.72916 | 54.674 |
| 5 | 65.585 | (D5) | | |
| 6(ASP) | 52.459 | 0.400 | 1.80139 | 45.450 |
| 7(ASP) | 5.422 | 2.735 | | |
| 8 | −21.000 | 0.450 | 1.80420 | 46.503 |
| 9 | 9.743 | 0.200 | | |
| 10(ASP) | 8.150 | 1.280 | 2.00170 | 19.324 |
| 11(ASP) | 24.995 | (D11) | | |
| 12(STO) | INFINITY | 0.100 | | |
| 13(ASP) | 4.807 | 2.200 | 1.68893 | 31.161 |
| 14 | 13.299 | 0.839 | 1.94595 | 17.980 |
| 15 | 5.001 | 0.317 | | |
| 16 | 10.568 | 1.300 | 1.61800 | 63.390 |
| 17 | −10.568 | (D17) | | |
| 18(ASP) | 10.765 | 1.366 | 1.49710 | 81.560 |
| 19 | 50.000 | (D19) | | |
| 20 | INFINITY | 0.300 | 1.51680 | 64.200 |
| 21 | INFINITY | 0.500 | | |
| 22(IMG) | INFINITY | | | |

In the zoom lens 8, both surfaces (sixth surface and seventh surface) of the first negative lens L4 of the second lens group GR2, both surfaces (tenth surface and eleventh surface) of the positive lens L6 of the second lens group GR2, the object side surface (thirteenth surface) of the positive lens L7 of the third lens group GR3, and the object side surface (eighteenth surface) of the positive lens L10 of the fourth lens group GR4 are formed as aspheric surfaces. Table 23 shows, together with the conic constant κ, the 4th-order, 6th-order, 8th-order, and 10th-order aspheric surface coefficients A, B, C, and D of the aspheric surfaces in Numerical Example 8.

TABLE 23

| Si | κ | A | B | C | D |
|---|---|---|---|---|---|
| 6 | 8.46670E+00 | 1.84707E−03 | −9.78497E−05 | 2.04355E−06 | −1.67322E−08 |
| 7 | 0.00000E+00 | 1.95943E−03 | 1.41337E−05 | 1.18297E−06 | −2.60724E−07 |
| 10 | 1.98011E+00 | −1.67113E−03 | 1.05449E−04 | −7.90372E−06 | 0.00000E+00 |
| 11 | 0.00000E+00 | −1.08735E−03 | 1.04232E−04 | −8.18274E−06 | 1.33916E−07 |
| 13 | 0.00000E+00 | −7.75826E−04 | 2.36605E−06 | −1.77876E−06 | 0.00000E+00 |
| 18 | 0.00000E+00 | −1.04686E−04 | 4.55092E−06 | −9.67147E−08 | −5.81474E−12 |

In the zoom lens 8, during the power variation between the wide-angle end state and the telephoto end state, changes occur in an on-axis surface space D5 between the first lens group GR1 and the second lens group GR2, an on-axis surface space D11 between the second lens group GR2 and the aperture stop S, an on-axis surface space D17 between the third lens group GR3 and the fourth lens group GR4, and an on-axis surface space D19 between the fourth lens group GR4 and the cover glass CG. Table 24 shows, together with the focal length f, the F number Fno, and the half angle of view ω, variable spaces of respective on-axis surface spaces at the wide-angle end state, the middle focal length state, and the telephoto end state in Numerical Example 8.

TABLE 24

| | Wide-Angle | Middle Focal | Telsphoto |
|---|---|---|---|
| | End | Length | End |
| f | 4.70 | 15.59 | 51.85 |
| Fno | 2.88 | 3.86 | 4.54 |
| ω | 41.29 | 13.95 | 4.20 |
| D5 | 0.300 | 10.498 | 20.285 |
| D11 | 11.000 | 3.477 | 0.400 |
| D17 | 4.034 | 5.807 | 15.270 |
| D19 | 6.362 | 10.767 | 5.161 |

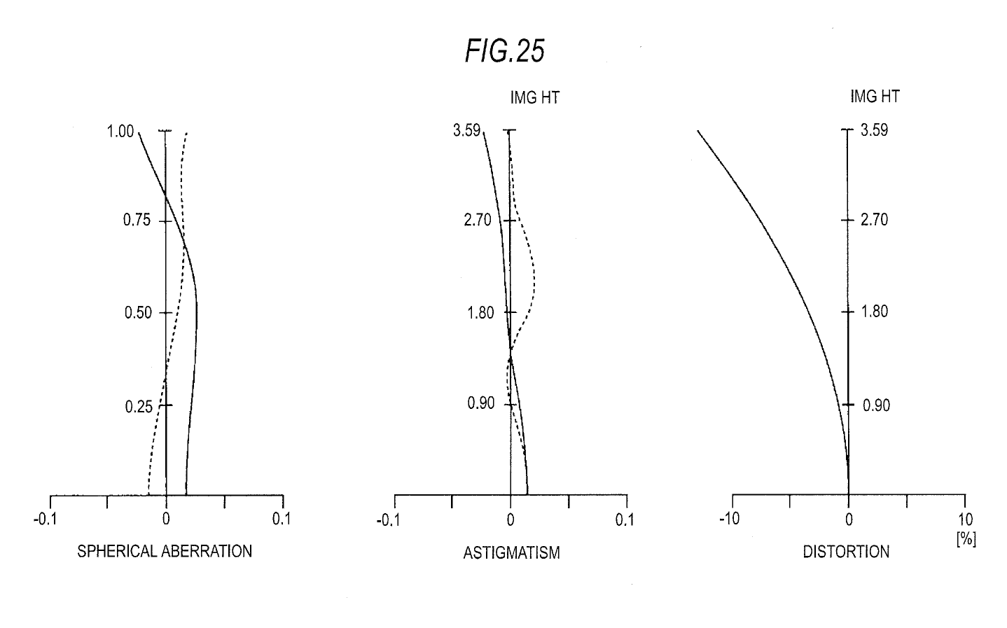

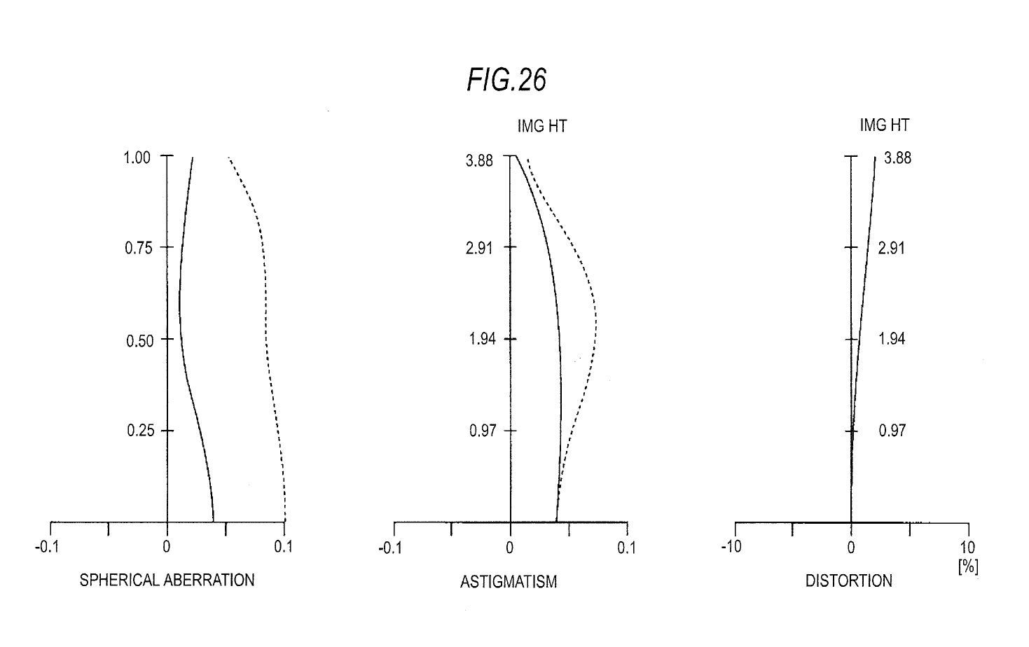

FIGS. 25 and 26 show diagrams of various aberrations in a state where the focus is at infinity in Numerical Example 8, where FIG. 25 shows a diagram of various aberrations at the wide-angle end state and FIG. 26 shows a diagram of various aberrations at the telephoto end state.

In each spherical aberration diagram of FIGS. 25 and 26, the solid line indicates the d-line (the wavelength of 587.6 nm), and the dashed line indicates the g-line (the wavelength of 435.8 nm). In each astigmatism diagram, the solid line indicates a value on the sagittal image plane, and the dashed line indicates a value on the meridional image plane.

As can be clearly seen from the aberration diagrams, in Numerical Example 8, it is possible to obtain excellent imaging performance by satisfactorily correcting various aberrations.

### [Respective Values of Conditional Expressions of Zoom Lenses]

Hereinbelow, respective values of conditional expressions of the zoom lenses according to the embodiments of the present technology will be described.

Table 25 shows the respective values of Conditional Expressions (1) to (8) of the zoom lenses 1 to 8.

TABLE 25

| | | Zoom Lens 1 | Zoom Lens 2 | Zoom Lens 3 | Zoom Lens 4 |
|---|---|---|---|---|---|
| | Move3(wt) | 10.80 | 10.80 | 10.70 | 15.50 |
| | fw | 4.80 | 4.80 | 4.81 | 4.81 |
| Conditional Expression (1) | 1.5 < Move3(wt)/fw < 3.5 | 2.25 | 2.25 | 2.23 | 3.22 |
| | Zoom | 10.78 | 10.76 | 8.99 | 12.10 |
| Conditional Expression (2) | 1.5 < 10 × {Move3(wt)/fw}/Zoom < 2.8 | 2.09 | 2.09 | 2.48 | 2.66 |
| | nd23 | 2.00170 | 1.94595 | 2.00170 | 2.00170 |
| | R23f | 8.00 | 7.80 | 8.66 | 8.13 |
| | f2 | −5.29 | −5.34 | −5.53 | −5.42 |
| Conditional Expression (3) | 1.2 < {R23f/(n23 − 1)}/\|f2\| < 1.9 | 1.51 | 1.54 | 1.56 | 1.50 |
| Conditional Expression (4) | νd23 < 20 | 19.324 | 17.980 | 19.324 | 19.324 |
| | f12w | −7.25 | −7.30 | −7.52 | −7.36 |
| | f12t | −35.66 | −35.16 | −30.12 | −36.74 |
| Conditional Expression (5) | 3.5 < f12t/f12w < 5.5 | 4.92 | 4.82 | 4.01 | 4.99 |
| Conditional Expression (6) | 1.0 < \|f2\|/fw < 1.2 | 1.10 | 1.11 | 1.15 | 1.13 |
| | f3 | 9.71 | 9.58 | 9.61 | 10.62 |
| Conditional Expression (7) | 1.95 < f3/fw < 2.5 | 2.02 | 1.99 | 2.00 | 2.21 |
| Conditional Expression (8) | νd4 > 80 | 81.560 | 81.560 | 81.560 | — |
| | | Zoom Lens 5 | Zoom Lens 6 | Zoom Lens 7 | Zoom Lens 8 |
| | Move3(wt) | 8.35 | 8.98 | 11.00 | 10.04 |
| | fw | 4.79 | 4.47 | 4.44 | 4.70 |
| Conditional Expression (1) | 1.5 < Move3(wt)/fw < 3.5 | 1.75 | 2.01 | 2.48 | 2.13 |
| | Zoom | 9.23 | 9.15 | 11.04 | 11.03 |
| Conditional Expression (2) | 1.5 < 10 × {Move3(wt)/fw}/Zoom < 2.8 | 1.89 | 2.20 | 2.24 | 1.94 |
| | nd23 | 2.00170 | 2.00170 | 2.00170 | 2.00170 |
| | R23f | 9.20 | 9.20 | 8.70 | 8.15 |
| | f2 | −5.47 | −5.31 | −5.20 | −5.50 |
| Conditional Expression (3) | 1.2 < {R23f/(n23 − 1)}/\|f2\| < 1.9 | 1.68 | 1.73 | 1.67 | 1.48 |
| Conditional Expression (4) | νd23 < 20 | 19.324 | 19.324 | 19.324 | 19.324 |
| | f12w | −7.74 | −7.44 | −7.14 | −7.54 |
| | f12t | −36.50 | −31.81 | −34.28 | −38.75 |
| Conditional Expression (5) | 3.5 < f12t/f12w < 5.5 | 4.71 | 4.28 | 4.80 | 5.14 |
| Conditional Expression (6) | 1.0 < \|f2\|/fw < 1.2 | 1.14 | 1.19 | 1.17 | 1.17 |
| | f3 | 9.77 | 9.46 | 9.63 | 9.83 |
| Conditional Expression (7) | 1.95 < f3/fw < 2.5 | 2.04 | 2.12 | 2.17 | 2.09 |
| Conditional Expression (8) | νd4 > 80 | 81.560 | 81.560 | 81.560 | 81.560 |

As can be seen from Table 25, the zoom lenses 1 to 8 are configured to satisfy Conditional Expressions (1) to (8).

### [Configuration of Imaging Apparatus]

In an imaging apparatus according to the present technology, a zoom lens includes, in order from the object side to the image side: a first lens group that has a positive refractive power; a second lens group that has a negative refractive power; a third lens group that has a positive refractive power; and a fourth lens group that has a positive refractive power.

Further, in the zoom lens of the imaging apparatus according to the present technology, during zooming from the wide-angle end to the telephoto end, the first lens group moves toward the object side so as to increase a space between the first lens group and the second lens group, and the third lens group moves toward the object side so as to decrease a space between the third lens group and the second lens group.

By making the zoom lens have the above-mentioned configuration, it is possible to maximize a power variation effect of the third lens group and the second lens group highly contributing to a power variation effect of the optical system during zooming, and it is possible to reduce the size of the whole optical system by reducing the entire length thereof. Accordingly, even in a case of a high-power zoom lens of which the zoom ratio is greater than 7.5 magnifications, it is possible to sufficiently reduce the size thereof.

Further, as a most preferable example, in particular, it is preferable to increase a magnification ratio greater than 8.5 magnifications. In the zoom lens according to the present technology, it is possible to cope with such a high-level demand of the market.

In the zoom lens of the imaging apparatus according to the present technology, the second lens group is formed of three separate lenses of a first negative lens, a second negative lens, and a positive lens arranged in order from the object side to the image side. In addition, the object-side surface of the positive lens is formed as an aspheric surface having a shape of which the curvature becomes gradually smaller at a position closer to a peripheral portion thereof on the optical axis (refer to FIG. 1).

FIG. 1 conceptually shows the object-side surface of the positive lens in the second lens group, where SP represents a paraxial radius of curvature, and ASP represents an aspheric surface. Regarding the aspheric surface ASP, as the distance from the optical axis S toward the peripheral portion thereof decreases, the distance between the aspheric surface ASP and the paraxial radius of curvature SP in the optical axis direction is increased, and the curvature thereof is set to gradually decrease.

In the zoom lens of the imaging apparatus according to the present technology, the second lens group is formed of three separate lenses of the first negative lens, the second negative lens, and the positive lens arranged in order from the object side to the image side. In addition, the object-side surface of the positive lens is formed as an aspheric surface having a shape of which the curvature becomes gradually smaller at a position closer to the peripheral portion thereof on the optical axis.

By making the second lens group have the above-mentioned configuration, even when the second lens group is formed of a small number of lenses for example three lenses, it is possible to effectively correct a coma aberration of an angle of view at the periphery from the wide-angle end to the telephoto end and a spherical aberration of an angle of view on the axis at the telephoto end. Hence, it is possible to improve image quality.

Furthermore, the aspheric surface shape is particularly advantageous in the following cases: a case of designing a zoom lens of which the F number at the wide-angle end is less than or equal to 3.5 and the F number at the telephoto end is less than or equal to 6.0 and which is sufficiently fast at the time of normal photography; and a case of designing a high zoom lens of which the F number at the wide-angle end is less than 3.0 and the F number at the telephoto end is less than 5.0 and which is particularly fast and has a high aperture (refer to Examples 1 to 8 to be described later).

In the zoom lens of the imaging apparatus according to the present technology, the F number thereof at the wide-angle end is less than 3.0, and the zoom ratio thereof is greater than or equal to 7.5.

Further, in the imaging apparatus according to the present technology, the zoom lens satisfies the following Conditional Expression (1).

1.5<Move3(wt)/fw<3.5 (1)

Here, Move3(wt) is a movement distance of the third lens group during zooming from the wide-angle end to the telephoto end, and fw is a focal length of the whole optical system at the wide-angle end.

The Conditional Expression (1) defines the movement distance of the third lens group during zooming from the wide-angle end to the telephoto end.

If the resulting value of the Conditional Expression (1) becomes excessively larger than the upper limit thereof, the power variation effect caused by the third lens group becomes too large. Hence, the power variation effect caused by the first lens group and the second lens group relatively decreases. As a result, the magnification ratio of the entrance pupil diameter becomes insufficient. Thus, it is difficult to set the F number at the telephoto end so as to achieve a sufficiently high speed.

In contrast, if the resulting value of the Conditional Expression (1) becomes excessively smaller than the lower limit thereof, the power variation effect caused by the third lens group that contributes most to the power variation becomes insufficient. Hence, it is difficult to sufficiently increase the magnification ratio.

Accordingly, by making the zoom lens satisfy the Conditional Expression (1), a favorable power variation effect caused by the first lens group and the second lens group is secured, and thus the F number at the telephoto end can be set to achieve a sufficiently high speed, and a favorable power variation effect caused by the third lens group is secured, and thus it is possible to sufficiently increase the magnification ratio.

### [Embodiment of Imaging Apparatus]

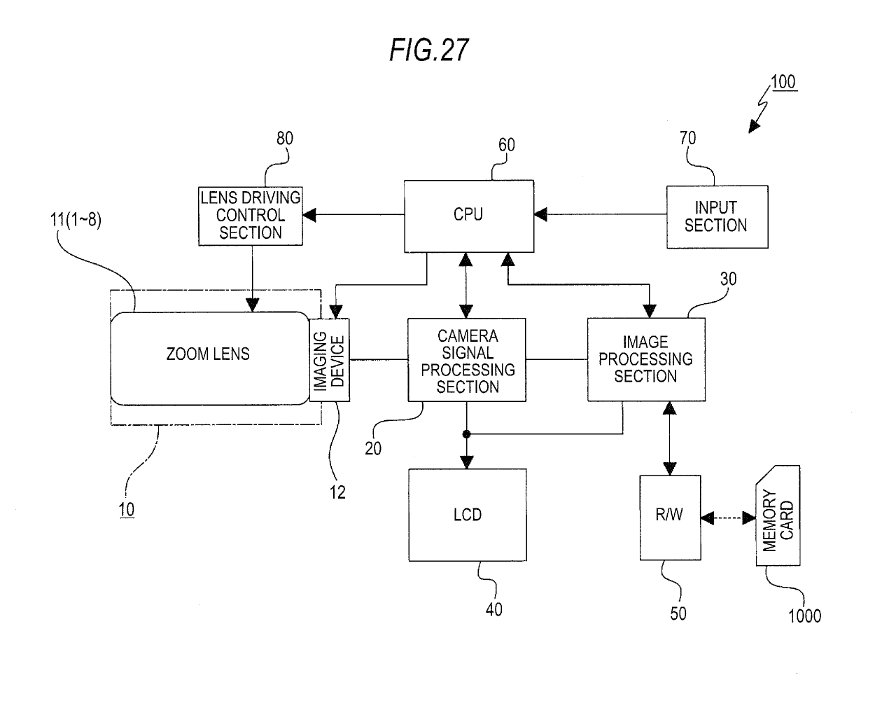

FIG. 27 shows a block diagram of a digital still camera as the imaging apparatus according to an embodiment of the present technology.

The imaging apparatus (the digital still camera) 100 includes: a camera block 10 that has a function of capturing an image; a camera signal processing section 20 that performs a signal processing such as an analog-to-digital conversion processing on a captured-image signal; an image processing section 30 that performs a process of recording and reproducing the image signal. Further, the imaging apparatus 100 includes: an LCD (Liquid Crystal Display) 40 that displays the captured image and the like; a R/W (reader/writer) 50 that writes and reads image signals in the memory card 1000; a CPU (Central Processing Unit) 60 that controls the entire imaging apparatus; an input section 70, such as various switches, that is used for a user's operation input; and a lens driving control section 80 that controls driving of the lens within the camera block 10.

The camera block 10 includes: an optical system including the zoom lens 11 (one of the zoom lenses 1 to 8 according to the embodiment of the present technology); and an imaging device 12 such as a CCD (Charge Coupled Device) sensor, a CMOS (Complementary Metal Oxide Semiconductor) sensor or the like.

The camera signal processing section 20 is configured to perform various signal processes, such as a process of conversion into a digital signal, noise removal, image quality correction, and a process of conversion into luminance and chromatic difference signals, on the output signal which is output from the imaging device 12.

The image processing section 30 is configured to perform a process of encoding for compression and decoding for decompression on an image signal based on a predetermined image data format, a process of conversion of data specification such as resolution, and the like.

The LCD 40 has a function to display various data such as a condition of the operation performed by a user with the aid of the input section 70 and a captured image.

The R/W 50 is configured to write image data, which is encoded by the image processing section 30, into the memory card 1000 and additionally read the image data which is recorded on the memory card 1000.

The CPU 60 functions as a control processing section to control all the circuit blocks within the imaging apparatus 100, and controls the circuit blocks on the basis of the instruction input signals and the like from the input section 70.

The input section 70 includes, for example, a shutter release button for performing a shutter operation, a selection switch for selecting operation modes, and the like. The input section 70 is configured to output the instruction input signal in response to the user's operation to the CPU 60.

The lens driving control section 80 is configured to control a motor, which is not shown in the drawing, for driving the lenses within the zoom lens 11 on the basis of the control signal from the CPU 60.

The memory card 1000 is, for example, a semiconductor memory which is removable from a slot connected to the R/W 50.

Next, operations of the imaging apparatus 100 will be described.

When the photographing is standby, an image signal captured by the camera block 10 under the control of the CPU 60 is output to the LCD 40 through the camera signal processing section 20 so as to be displayed as a camera-through-image. Further, when the instruction input signal for zooming is input from the input section 70, the CPU 60 outputs a control signal to the lens driving control section 80, and moves prescribed lenses within the zoom lens 11 on the basis of the control of the lens driving control section 80.

When the not-shown shutter of the camera block 10 is operated by the instruction input signal from the input section 70, the captured image signal is output from the camera signal processing section 20 to the image processing section 30, is encoded for compression, and is converted into digital data of the predetermined data format. The converted data is output to the R/W 50 and is written in the memory card 1000.

For focusing, the lens driving control section 80 moves the prescribed lenses of the zoom lens 11 on the basis of the control signal received from the CPU 60, for example, when the shutter release button of the input section 70 is pressed halfway or pressed fully for recording (photography).

For reproduction of image data recorded in the memory card 1000, the R/W 50 reads out the prescribed image data from the memory card 1000 in response to the operation performed on the input section 70. The readout image data is decoded for decompression by the image processing section 30 and the reproduced image signal is then output to the LCD 40, thereby displaying the reproduced image.

In addition, the embodiment has described the case where the imaging apparatus according to the embodiment of the present technology is applied to a digital still camera. However, the application range of the imaging apparatus is not limited to the digital still camera, and it may also be widely applied to, for example, camera sections of digital input/output apparatuses such as a digital video camera, a mobile phone equipped with a camera, and a PDA (Personal Digital Assistant) equipped with a camera.

### [Others]

In the imaging apparatus according to the present technology and the zoom lens according to the present technology, a lens, which has no lens power in practice, may be disposed, and a lens group including such a lens may be disposed in addition to the first to fourth lens groups. In this case, the imaging apparatus according to the present technology and the zoom lens according to the present technology may include practically five or more lens groups including the lens group which is disposed in addition to the first to fourth lens groups.

### [Present Technology]

The present technology may be implemented as the following configurations.

<1> A zoom lens including, in order from the object side to the image side: a first lens group that has a positive refractive power; a second lens group that has a negative refractive power; a third lens group that has a positive refractive power; and a fourth lens group that has a positive refractive power, wherein during zooming from a wide-angle end to a telephoto end, the first lens group moves toward the object side so as to increase a space between the first lens group and the second lens group, and the third lens group moves toward the object side so as to decrease a space between the third lens group and the second lens group, wherein the second lens group is formed of three separate lenses of a first negative lens, a second negative lens, and a positive lens arranged in order from the object side to the image side, wherein an object-side surface of the positive lens is formed as an aspheric surface having a shape of which a curvature becomes gradually smaller at a position closer to a peripheral portion thereof on an optical axis, wherein an F number thereof at the wide-angle end is less than 3.0, and a zoom ratio thereof is greater than or equal to 7.5, and wherein the following Conditional Expression (1) is satisfied

1.5<Move3(wt)/fw<3.5, (1)

where Move3(wt) is a movement distance of the third lens group during zooming from the wide-angle end to the telephoto end, and fw is a focal length of the whole optical system at the wide-angle end.

<2> The zoom lens according to <1), wherein the following Conditional Expression (2) is satisfied

1.5<10×{Move3(wt)/fw}/Zoom<2.8, (2)

where Zoom is a zoom ratio of the whole optical system during zooming from the wide-angle end to the telephoto end.

<3> The zoom lens according to <1> or <2>, wherein the following Conditional Expression (3) is satisfied

1.2<{R23f/(nd23−1)}/|f2|<1.9, (3)

where R23f is a paraxial radius of curvature of the object-side surface of the positive lens in the second lens group, nd23 is a refractive index of the positive lens in the second lens group at the d-line, and f2 is a focal length of the second lens group.

<4> The zoom lens according to any one of <1> to <3>, wherein the following Conditional Expression (4) is satisfied

vd23<20, (4)

where, vd23 is an Abbe number of the positive lens in the second lens group at the d-line.

<5> The zoom lens according to any one of <1> to <4>, wherein an aperture stop moves integrally with the third lens group in an optical axis direction, and wherein the following Conditional Expression (5) is satisfied

3.5<f12t/f12w<5.5, (5)

where f12w is a composite focal length of the first lens group and the second lens group at the wide-angle end, and f12t is a composite focal length of the first lens group and the second lens group at the telephoto end.

<6> The zoom lens according to any one of <1> to <5>, wherein the following Conditional Expression (6) is satisfied

1.0<f2|/fw<1.2, (6)

where f2 is a focal length of the second lens group.

<7> The zoom lens according to any one of <1> to <6>, wherein the following Conditional Expression (7) is satisfied

1.95<f3/fw<2.5, (7)

where f3 is a focal length of the third lens group.

<8> The zoom lens according to any one of <1> to <7>, wherein during focusing from an infinitely distant object to a close-range object, the fourth lens group is brought into focus by moving the lens group in the optical axis direction so as to change a position of an image plane.

<9> The zoom lens according to any one of <1> to <8>, wherein the fourth lens group is formed of only one positive lens, and wherein the following Conditional Expression (8) is satisfied

vd4>80, (8)

where vd4 is an Abbe number of the positive lens of the fourth lens group at the d-line.

<10> The zoom lens according to any one of <1> to <9>, wherein the fourth lens group is formed of only a cemented lens which is formed by cementing two lenses of a positive lens and a negative lens arranged in order from the object side to the image side.

<11> An imaging apparatus including: a zoom lens; and an imaging device that converts an optical image, which is formed by the zoom lens, into an electrical signal, wherein the zoom lens includes, in order from the object side to the image side, a first lens group that has a positive refractive power, a second lens group that has a negative refractive power, a third lens group that has a positive refractive power, and a fourth lens group that has a positive refractive power, wherein during zooming from a wide-angle end to a telephoto end, the first lens group moves toward the object side so as to increase a space between the first lens group and the second lens group, and the third lens group moves toward the object side so as to decrease a space between the third lens group and the second lens group, wherein the second lens group is formed of three separate lenses of a first negative lens, a second negative lens, and a positive lens arranged in order from the object side to the image side, wherein an object-side surface of the positive lens is formed as an aspheric surface having a shape of which a curvature becomes gradually smaller at a position closer to a peripheral portion thereof on an optical axis, wherein an F number thereof at the wide-angle end is less than 3.0, and a zoom ratio thereof is greater than or equal to 7.5, and wherein the following Conditional Expression (1) is satisfied

1.5<Move3(wt)/fw<3.5, (1)

where Move3(wt) is a movement distance of the third lens group during zooming from the wide-angle end to the telephoto end, and fw is a focal length of the whole optical system at the wide-angle end.

<12> The zoom lens according to any one of <1> to <10>, or the imaging apparatus according to <11>, wherein a lens, which has no power in practice, is further provided.

The shapes of components and the numerical values described or shown in the above-mentioned embodiments are only illustrative examples of the embodiments for carrying out the present technology, and they should not be interpreted as limiting the technical scope of the present technology.

The present disclosure contains subject matter related to that disclosed in Japanese Priority Patent Application JP 2011-139710 filed in the Japan Patent Office on Jun. 23, 2011, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A zoom lens comprising, in order from the object side to the image side:
a first lens group that has a positive refractive power;
a second lens group that has a negative refractive power;
a third lens group that has a positive refractive power; and
a fourth lens group that has a positive refractive power,
wherein during zooming from a wide-angle end to a telephoto end, the first lens group moves toward the object side so as to increase a space between the first lens group and the second lens group, and the third lens group moves toward the object side so as to decrease a space between the third lens group and the second lens group,
wherein the second lens group is formed of three separate lenses of a first negative lens, a second negative lens, and a positive lens arranged in order from the object side to the image side,
wherein an object-side surface of the positive lens is formed as an aspheric surface having a shape of which a curvature becomes gradually smaller at a position closer to a peripheral portion thereof on an optical axis,
wherein an F number thereof at the wide-angle end is less than 3.0, and a zoom ratio thereof is greater than or equal to 7.5, and
wherein the following Conditional Expression (1) is satisfied
1.5<Move3(wt)/fw<3.5, (1)
where
Move3(wt) is a movement distance of the third lens group during zooming from the wide-angle end to the telephoto end, and
fw is a focal length of the whole optical system at the wide-angle end.

2. The zoom lens according to claim 1, wherein the following Conditional Expression (2) is satisfied
1.5<10×{Move3(wt)/fw}/Zoom<2.8, (2)
where
Zoom is a zoom ratio of the whole optical system during zooming from the wide-angle end to the telephoto end.

3. The zoom lens according to claim 1, wherein the following Conditional Expression (3) is satisfied
1.2<{R23f/(nd23−1)}/|f2|<1.9, (3)
where
R23f is a paraxial radius of curvature of the object-side surface of the positive lens in the second lens group,
nd23 is a refractive index of the positive lens in the second lens group at the d-line, and
f2 is a focal length of the second lens group.

4. The zoom lens according to claim 1, wherein the following Conditional Expression (4) is satisfied
vd23<20, (4)
where
vd23 is an Abbe number of the positive lens in the second lens group at the d-line.

5. The zoom lens according to claim 1,
wherein an aperture stop moves integrally with the third lens group in an optical axis direction, and
wherein the following Conditional Expression (5) is satisfied
3.5<f12t/f12w<5.5, (5)
where
f12w is a composite focal length of the first lens group and the second lens group at the wide-angle end, and
f12t is a composite focal length of the first lens group and the second lens group at the telephoto end.

6. The zoom lens according to claim 1, wherein the following Conditional Expression (6) is satisfied
1.0<|f2|/fw<1.2, (6)
where
f2 is a focal length of the second lens group.

7. The zoom lens according to claim 1, wherein the following Conditional Expression (7) is satisfied
1.95<f3/fw<2.5, (7)
where
f3 is a focal length of the third lens group.

8. The zoom lens according to claim 1, wherein during focusing from an infinitely distant object to a close-range object, the fourth lens group is brought into focus by moving the lens group in the optical axis direction so as to change a position of an image plane.

9. The zoom lens according to claim 1,
wherein the fourth lens group is formed of only one positive lens, and
wherein the following Conditional Expression (8) is satisfied
vd4>80, (8)
where
vd4 is an Abbe number of the positive lens of the fourth lens group at the d-line.

10. The zoom lens according to claim 1, wherein the fourth lens group is formed of only a cemented lens which is formed by cementing two lenses of a positive lens and a negative lens arranged in order from the object side to the image side.

11. An imaging apparatus comprising:
a zoom lens; and
an imaging device that converts an optical image, which is formed by the zoom lens, into an electrical signal,
wherein the zoom lens includes, in order from the object side to the image side
a first lens group that has a positive refractive power,
a second lens group that has a negative refractive power,
a third lens group that has a positive refractive power, and
a fourth lens group that has a positive refractive power,
wherein during zooming from a wide-angle end to a telephoto end, the first lens group moves toward the object side so as to increase a space between the first lens group and the second lens group, and the third lens group moves toward the object side so as to decrease a space between the third lens group and the second lens group,
wherein the second lens group is formed of three separate lenses of a first negative lens, a second negative lens, and a positive lens arranged in order from the object side to the image side,
wherein an object-side surface of the positive lens is formed as an aspheric surface having a shape of which a curvature becomes gradually smaller at a position closer to a peripheral portion thereof on an optical axis,
wherein an F number thereof at the wide-angle end is less than 3.0, and a zoom ratio thereof is greater than or equal to 7.5, and
wherein the following Conditional Expression (1) is satisfied
1.5<Move3(wt)/fw<3.5 (1)
where
Move3(wt) is a movement distance of the third lens group during zooming from the wide-angle end to the telephoto end, and
fw is a focal length of the whole optical system at the wide-angle end.
